(19) United States
(12) Patent Application Publication
(10) Pub. No.: US 2017/0011444 A1
(43) Pub. Date: Jan. 12, 2017

(54) Intelligent Purchasing Systems and Methods

(71) Applicant: LF Technology Development Corporation Limited, London (GB)

(72) Inventors: Alexander Greystoke, Lakeway, TX (US); Shy Blick, Austin, TX (US)

(73) Assignee: LF Technology Development Corporation Limited, London (GB)

(21) Appl. No.: 15/205,818

(22) Filed: Jul. 8, 2016

Related U.S. Application Data
(63) Continuation-in-part of application No. 14/327,543, filed on Jul. 9, 2014.
Application No. 14/327,543 is a continuation-in-part of application No. 14/169,058, filed on Jan. 30, 2014.
Application No. 14/327,543 is a continuation-in-part of application No. 14/169,060, filed on Jan. 30, 2014.
(60) Provisional application No. 61/844,353, filed on Jul. 9, 2013.
(60) Provisional application No. 61/844,350, filed on Jul. 9, 2013.
(60) Provisional application No. 61/844,355, filed on Jul. 9, 2013.
(60) Provisional application No. 61/759,314, filed on Jan. 31, 2013.
(60) Provisional application No. 61/759,317, filed on Jan. 31, 2013.

(51) Int. Cl. G06Q 30/06; G06F 17/30

(52) U.S. Cl. CPC G06Q 30/0629; G06F 17/30867

(57) ABSTRACT

In some embodiments, a system may include a network interface configured to communicate with a network, a processor coupled to the network interface, and a memory coupled to the processor. The instructions, when executed, may cause the processor to automatically grab a selected product on behalf of the user.

### CROSS-REFERENCE TO RELATED APPLICATION(S)

The present application is a continuation-in-part of and claims priority to U.S. patent application Ser. No. 14/327,543, filed on Jul. 9, 2014, and entitled “Computer-Aided Decision Systems,” which is a continuation-in-part of and claims priority to U.S. patent application Ser. No. 14/169,058, filed on Jan. 30, 2014, entitled “VIRTUAL PURCHASING ASSISTANT”, which claimed priority to U.S. Provisional Patent Application No. 61/759,314, filed on Jan. 31, 2013, and entitled “VIRTUAL PURCHASING ASSISTANT”; and is also a continuation-in-part of and claims priority to U.S. patent application Ser. No. 14/169,060 filed on Jan. 30, 2014, entitled “DUAL PUSH SALES OF TIME SENSITIVE INVENTORY”, which claimed priority to U.S. Provisional Patent Application No. 61/759,317, filed on Jan. 31, 2013, and entitled “DUAL PUSH SALES OF TIME SENSITIVE INVENTORY”; and is also a non-provisional of and claims priority to U.S. Provisional Patent Application No. 61/844,355, filed on Jul. 9, 2013, entitled “INVENTORY SEARCHING WITH AN INTELLIGENT RECOMMENDATION ENGINE”; is also a non-provisional of and claims priority to U.S. Provisional Patent Application No. 61/844,353, filed on Jul. 9, 2013, entitled “SINGLE PAGE TRAVEL SEARCH AND RESULTS MODIFICATION”; and is also a non-provisional of and claims priority to U.S. Provisional Patent Application No. 61/844,350, filed on Jul. 9, 2013, entitled “SEARCHING FOR INVENTORY USING AN ARTIFICIAL INTELLIGENCE PRIORITIZATION ENGINE”; the contents of all of which are hereby incorporated by reference in their entireties.

### FIELD

The present disclosure is generally related to intelligent purchasing systems and methods. More particularly, the present disclosure is related to computer-aided search systems and methods utilizing artificial intelligence configured to automatically identify items of value to a user and to automatically hold and optionally purchase an item of value on behalf of the user.

### BACKGROUND

Computers are complex machines that allow individuals to receive the benefit of significant computational processing power. However, even with sophisticated software, computers often merely perform the functions they are specifically programmed to do. The computer is generally ignorant of the user's needs. For example, when a user performs a search for information via a computer, the quality of search and thus the quality of the search result will be limited by what the search system is programmed to return and may be further limited to the keywords provided by the user.

### SUMMARY

In some embodiments, a system may include a network interface configured to communicate with a network, a processor coupled to the network interface, and a memory coupled to the processor. The instructions, when executed, may cause the processor to automatically grab a selected product on behalf of the user.

The systems and processes described herein can provide continuous, intelligent, personally targeted, real-time decision-making tailored specifically to user preferences, behaviors, locations, or other factors and influenced by the collective experience of multiple users. In certain embodiments, the systems and methods may include a computing system having artificial or augmented intelligence that may be configured to identify what a user may be looking for or want, and then select and present results for the particular user. In some embodiments, the system can also generate a graphical user interface (GUI) to present search results and optionally supplemental information derived from a plurality of users over time (i.e., collective information).

Further, in some embodiments, the system may grab a product or a service on behalf of a user, such as by automatically purchasing the product, by automatically holding the product on behalf of the user and then alerting the user of the hold in order to allow the user to complete or to authorize completion of the purchase, or any combination thereof. Additionally, the system may be configured to grab a product or service on behalf of a group of users. In some instances, the system may grab a product based on a set of parameters defined by a user, based on an initial search, based on a voice request, based on a previous purchase, or any combination thereof.

Embodiments of an intelligent purchasing system and method may include a processor and a memory accessible to the processor. The memory may be configured to store instructions that, when executed, cause the processor to provide one or more recommended searches to an interface based on collective information and in response to input data at the interface. The memory may further store instructions that, when executed, cause the processor to provide a graphical user interface including one or more search results based on at least one of the input data and the one or more recommended searches. In some embodiments, with respect to the one or more recommended searches, the system may provide recommendations, advice, associated data, or any combination thereof.

In some embodiments, a system may include a network interface configured to communicate with a network, a processor coupled to the network interface, and a memory coupled to the processor. The instructions, when executed, may cause the processor to receive seed data corresponding to a product of interest to a user, search one or more data sources to identify a plurality of products that correspond to the seed data, and automatically grab a selected product of the plurality of products on behalf of the user. The seed data may be provided by the user entering information related to a product or service of interest, may be determined from past behavior of the user, or may be received from another source.

In certain embodiments, the system may receive seed data defining a set of parameters corresponding to products or services of interest to a particular user. In some embodiments, the system may automatically search for products or services corresponding to the set of parameters. In response to identifying a product or service that corresponds to the set of parameters, the system may automatically “grab” the product or service on behalf of the user. The term “grab” as used herein may include purchasing the product on behalf of the user, initiating a hold on a particular product and communicating with the user to complete the transaction, or any combination thereof.

In some examples, the system may be unable to identify a product or service that satisfies all of the parameters. In such a situation, the system may be configured to determine a best value of identified products or services that satisfy some of the parameters and may provide the identified products or services to the user. Further or in the alternative, the system may continue to retry the search until a product or service that satisfies all of the parameters is found. In some embodiments, the system may also provide the parameters to one or more suppliers, providing a lead to a supplier, and allowing the supplier to offer a product or service that may satisfy the parameters. If an offer is received that matches the parameters, the system may automatically grab the corresponding product or service on behalf of the user.

In some embodiments, the seed data may be received from inputs provided by a user via a graphical user interface. In an example, the system may provide a web page through which the user may login and may configure one or more parameters indicating a type of product or service desired and how and one or more other related parameters. Alternatively, the seed data may be received via a voice request, from another computing system, from inputs provided by an administrator of the system, or any combination thereof.

In the context of travel as an example, the user may configure one or more user-selectable elements presented within the web page to look for any flight that departs from Austin, Tex. and arrives in Miami, Fla. on Dec. 23, 2016. The user may also configure other parameters, such as “maximum price”, “departure time”, “arrival time”, and so on. There is no limit to the number of parameters that can be selected, even parameters such as airline, type of plane, mileage, duration of the flight, number of stopovers, and so on. The system may then search available inventory (from a plurality of data sources), and if an available flight is found, the system may automatically “grab” the ticket on behalf of the user. As mentioned above, if no option is found that satisfies the user-configured parameters, the system may continue to search and may also communicate the parameters to one or more suppliers as potential leads, allowing the suppliers to make a personalized offer that meets the user's needs. Other options are also possible.

In certain embodiments, a plurality of options may be available for purchase. The system may utilize an artificial intelligence engine configured with one or more personas associated with the particular user to determine a “best” option for the particular user or the particular user's persona (i.e., a digital representation of the user) and may grab that particular option. The determination of “best” may be based on user preferences from prior purchase, based on the persona associated with the user, based on “collective” intelligence derived from other purchasers, based on experts identified by the system, based on other information, or any combination thereof.

In some embodiments, the seed data provided by the user may be received in the form of an initial search. From a search results page, the user may configure the system to continue to search on his or her behalf to find a better option that satisfies one or more parameters. In some embodiments, the system may make recommendations and may suggest parameter changes or suggest that the user authorize the system to automatically grab a product or service if one is found that meets the parameters, for example, due to inventory disappearing. The system may then continue searching, even after the user has logged off the system, and may automatically “grab” the product or service on behalf of the user when an option is found that satisfies the parameters defined by the user.

In some embodiments, a system may be configured to continuously search for better options on behalf of a user. The better options may be determined from a purchase made by the user, such as the purchase of an airline ticket. In some examples, the system may be configured to monitor price fluctuations and to automatically grab a better value airline ticket when the value exceeds the cost by at least a threshold amount or if the value is materially better based on other considerations. Other embodiments are also possible.

In certain embodiments, a system may include a network interface configured to communicate with a network, a processor coupled to the network interface, and a memory coupled to the processor. The memory is configured to store instructions that, when executed, may cause the processor to automatically search one or more sources to identify a plurality of options for a user after the user has completed a purchase of an option. The memory may further include instructions that cause the processor to automatically determine a first option of the plurality of options that has a better value for the user than the purchased option and automatically grab the first option on behalf of the user. In some aspects, the instructions may cause the processor to automatically purchase the first option on behalf of the user.

In other embodiments, a method may include automatically receiving, after the user has completed a purchase of an option, data related to a plurality of options for a user from one or more data sources over a network. The plurality of options may correspond to alternatives to the option purchased by the user. The method may further include automatically processing the plurality of options using an artificial intelligence engine configured according to a persona associated with the user to determine a first option of the plurality of options that has a better value for the user than the purchased option. Additionally, the method can include automatically grabbing the first option on behalf of the user using the artificial intelligence engine to communicate with a data source associated with the first option through the network.

In still other embodiments, a system may include a network interface configured to communicate with a network, a processor coupled to the network interface, and a memory coupled to the processor. The memory may be configured to store instructions that, when executed, may cause the processor to receive data corresponding to an available item of value to a user at an artificial intelligence engine and automatically grab the available item on behalf of the user.

### BRIEF DESCRIPTION OF THE DRAWINGS

FIG. 1 depicts a block diagram of an intelligent purchasing system, in accordance with certain embodiments of the present disclosure.

FIG. 2 depicts a block diagram of an intelligent purchasing system, in accordance with certain embodiments of the present disclosure.

FIG. 3 illustrates a flow diagram of a method of automatically purchasing or holding a product on behalf of a user, in accordance with certain embodiments of the present disclosure.

FIG. 4 depicts a flow diagram of a method of automatically grabbing a product on behalf of a user, in accordance with certain embodiments of the present disclosure.

FIG. 5 depicts a flow diagram of a method of grabbing products on behalf of a group of users, in accordance with certain embodiments of the present disclosure.

FIG. 6 depicts a flow diagram of a method of grabbing a product offered by a supplier based on parameters of interest, in accordance with certain embodiments of the present disclosure.

FIG. 7 depicts a flow diagram of a method of grabbing a product corresponding to user parameters or expert parameters, in accordance with certain embodiments of the present disclosure.

FIG. 8 depicts a flow diagram of a method of providing an intelligent purchasing system, in accordance with certain embodiments of the present disclosure.

FIG. 9 depicts a flow diagram of a method of automatically purchasing an item on behalf of a user based on a determined value to the user, in accordance with certain embodiments of the present disclosure.

FIG. 10 illustrates a flow diagram of a method of automatically grabbing an item on behalf of a user, in accordance with certain embodiments of the present disclosure.

FIG. 11 is a diagram of a GUI including user-selectable options accessible by a user to configure the system to grab a travel-related product or service on behalf of a user, in accordance with certain embodiments of the present disclosure.

FIG. 12 is a diagram of a second GUI including user-selectable options accessible by a user to configure the system to grab a travel-related product or service on behalf of a user, in accordance with certain embodiments of the present disclosure.

FIG. 13 depicts a diagram of a third GUI accessible to configure a continuous search and intelligent purchasing, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

In the following detailed description of the embodiments, reference is made to the accompanying drawings which form a part hereof, and in which are shown by way of examples. The features of the various embodiments and examples described herein may be combined, exchanged, removed, other embodiments utilized, and structural changes made without departing from the scope of the present disclosure.

One or more aspects or features of the subject matter described herein can be implemented in digital electronic circuitry, integrated circuitry, application specific integrated circuits (ASICs), field programmable gate arrays (FPGAs), another dedicated hardware implementation, computer hardware, firmware, software, or any combination thereof. In accordance with various embodiments, the methods and functions described herein may be implemented as one or more software programs executable by a computer processor of a computing device, such as a laptop computer, a server, a desktop computer, or a handheld computing device, such as a tablet computer, a personal digital assistant (PDA), or smart phone. Further, in some embodiments, the methods and functions described herein may be implemented as a device, such as a non-volatile computer readable storage device or memory device, including instructions that, when executed, cause a processor to perform the methods and functions.

Unlike conventional search systems, embodiments of an intelligent purchasing system may be directed to identifying outcomes that may satisfy a particular request, a search, a set of parameters, or any combination thereof and automatically grabbing an identified outcome (a product or service) on behalf of the user. The initial data or seed data may define a set of parameters that the system can use to identify an outcome (product or service) on behalf of the user or the user's digital persona. In some embodiments, the initial or seed data may be received from an electronic message, a voice-to-text conversion, a web page submission form, user input, an artificial intelligence engine, another source, or any combination thereof. The initial data may define a set of parameters for a product or service of interest to a user, which parameters may be used to search, to generate leads for suppliers, to identify related inventory, or any combination thereof.

In some embodiments, the system may be configured to identify potential outcomes that may be based on a user's request and optionally to identify potential outcomes related in some way to the user's request that may be based on collective intelligence derived from other user's decisions, other user's searches, information determined by artificial intelligence, and so on. In some embodiments, the intelligent purchasing system may identify multiple outcomes, some of which may be more important than others, some of which may be critical to the user, and some of which may not be as important. In some embodiments, the system may be configured to determine the outcome that the user may be trying to achieve as an outcome and can predict what results are most likely to achieve the outcome, what flexibility there is in achieving the outcome, what the value of each path to an outcome is relating to any number of potential factors such as price, convenience, comfort etc. allowing an assessment to be made of best true value and best true value to that user at that time. The system may then automatically grab the outcome (i.e., product or service) that has the “best true value” to the user, such as by automatically purchasing the outcome or by placing a hold on the outcome and alerting the user to acquire authorization to complete the transaction.

If an outcome is not identified that satisfies the parameters, the system may continue to retry the search continuously or periodically (such as when inventory options typically change or when suppliers update their inventory listings). Further, in some embodiments, where an outcome is not identified that satisfies the parameters, the system may communicate the parameters to one or more suppliers as a lead generator to enable a supplier to offer a product or service to satisfy the parameters. In response to an offer, the system may automatically grab the product on behalf of the user.

In some embodiments, a computing system can analyze outcomes and sub-outcomes individually and collectively to identify better options for a particular user. In some embodiments, the system may compare search results to search results identified using a query to determine which results are better based on the collective information and based on a user's persona. The user's persona may include a collection of data points that represent the user's decision-making at a point in time given a set of available options. As the user is presented with options and makes decisions, the system may learn the user's preferences over time, updating the user's persona with each decision, until the digital persona may become a digital representation of the user as a decision-maker. A persona may include a digital representation of an individual consumer, groups of consumers, an organization, one or more other entities, or any combination thereof. Further, at any point in time, the user may make decisions according to a particular decision-making role, such as an employee role, a leisure planning role, a family role, an individual role, and so on. The context of the decision-making may alter how the user makes decisions. The system may include multiple personas for a particular user, where each persona represents the user's decision making in a particular context or role. Initially, the system may determine (based on user interactions), which role best represents the user's decision-making, and may configure an artificial intelligence engine based on the selected persona and process the search results to compare them using the configured artificial intelligence engine.

Further, in some embodiments, the computing system may be configured to receive a seed input defining one or more parameters of a product or service of interest to the user or the user's persona. The seed data may include information provided by the user, such as by filling out a web-based form indicating the service or product that he or she is looking for and identifying some parameters of the service or product. Alternatively, the seed data may be supplied by a selected persona, may be received from an administrator, may be received from a speech-to-text converter, may be received from a faxed form, or any combination thereof. In some embodiments, the seed data may be received from a web page, from a prior search, from a scheduling module, from an artificial intelligence engine, from another source, or any combination thereof.

In response to receiving the seed data, the computing system may automatically search for a product or service that corresponds to the one or more parameters. The computing system may automatically “grab” an option on behalf of the user if an option is found that corresponds to the one or more parameters. In the event that the computing system can identify a plurality of options that satisfy the parameters, the computing system may utilize an artificial intelligence engine configured with at least one persona associated with the user to rank the various options based on the user's preferences, based on collective intelligence derived from other users, based on yield management data and other factors, or any combination thereof. The computing system may then “grab” the “best” option on behalf of the user. The term “grab” as used herein may include purchasing the product on behalf of the user, initiating a hold and communicating with the user to complete the transaction, or any combination thereof. In some embodiments, the system may prompt the user to authorize an automatic grab of an available product, such as when the inventory may be expiring or disappearing.

The computing system may, even after “grabbing” an option for the user, continue to search to identify a “better” option than the one that was purchased, and may automatically “grab” the better option on behalf of the user. If an option that satisfies the parameters is not found by the computing system, the system may continue to search until one is found. Further, whether or not an option is found that meets the parameters, the system may provide data related to the parameters to one or more suppliers to allow the suppliers to customize an option to meet the user's interest. If a qualifying offer is made, the system may automatically grab the qualifying offer on behalf of the user.

Additionally, the system may be configured to automatically grab one or more options on behalf of a group of users, where individual parameters may share some commonalities and may otherwise vary. In an example, a group of users traveling to a particular destination for an event may have a common destination and an overlapping window of time in which they may be present at the common destination; however, their particular travel preferences may otherwise vary. In such a case, the system may be configured by each user of the group to automatically grab options on behalf of each particular user according to that user's parameters or according to parameters associated with a persona corresponding to the user.

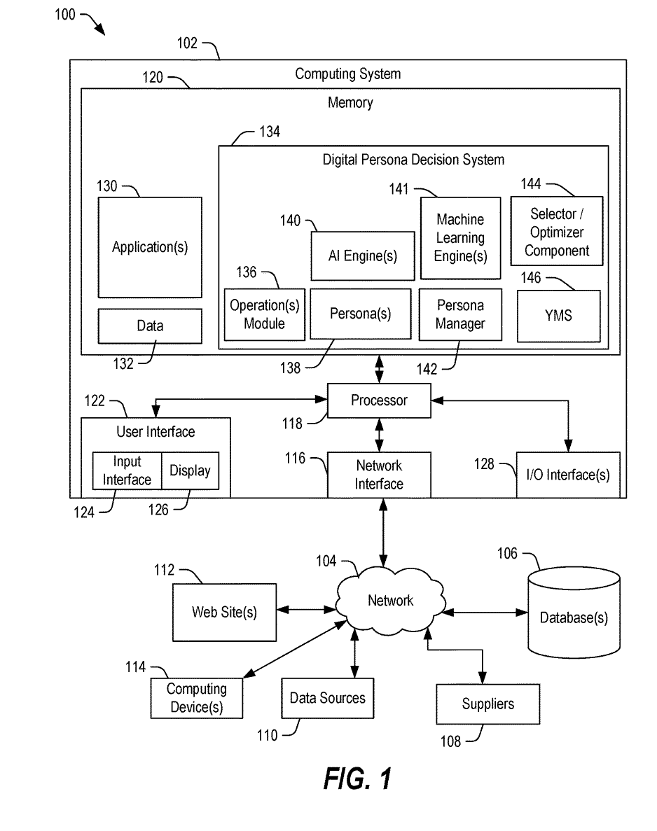

In the following discussion, search is used as a launching point to discuss the grab functionality; however, the grab functionality provided by the systems and methods described below may provide the framework for replacing search altogether. In an example, the user may be removed from the search process, enabling the system to determine products or services on behalf of the user automatically and in response to user-defined parameters. The user need not initiate a search, but rather the system can identify products or services for the user based on parameters provided by the user. One possible example of a system configured to automatically “grab” an option on behalf of a user is described below with respect to FIG. 1.

FIG. 1 depicts a block diagram of an intelligent purchasing system 100, in accordance with certain embodiments of the present disclosure. The intelligent purchasing system 100 can include a computing system 102 that may be configured to communicate through a network 104, such as the Internet. In certain embodiments, the computing system 102 may communicate via the network 104 with one or more databases 106, one or more suppliers 108, one or more other data sources 110, one or more other computing devices 111, one or more web sites 112, other data sources, or any combination thereof.

The computing system 102 may include a network interface 116 configured to communicate with the network 104. The computing system 102 may also include a processor 118 coupled to the network interface 116, to a user interface 122, to a memory 120, and to an input/output (I/O) interface 128. In some embodiments, the user interface 122 may include a display interface configured to couple to a display device and an interface (such as a Universal Serial Bus port) configured to couple to a keyboard, a mouse, or another input device to receive user input. In certain embodiments, the user interface 122 may include the input interface 124 and a display 126, such as a touchscreen.

The memory 120 may include a disc drive, a flash memory, cache memory, Random Access Memory (RAM), Read Only Memory (ROM), any other type of memory, or any combination thereof. At least a portion of the memory 120 may include a non-volatile memory configured to store data 132 and to store instructions that may be executed by processor 118 to perform a variety of functions and operations. The memory 120 may store one or more software applications 130 and a digital persona decision system 134. The digital persona decision system 134 may include an operations module 136, personas 138, a persona manager 142, one or more machine learning engines 141, a selector/optimizer component 144, and one or more artificial intelligence (AI) engines 140. The selector/optimizer component 144 can include a yield management system 146.

The intelligent purchasing system 100 can provide “better” or “best” search results to a client after an initial search has been completed or at the point that an initial search is requested. The “better” or “best” search results may be based on a client's query, desired outcome or outcomes, previous search results, yield management rules, group search results, other data, or any combination thereof. In some cases, the “better” or “best” results may be determined by artificial intelligence engines 140, a selector/optimizer 144, a yield management system 146, other components, or any combination thereof. In some embodiments, the intelligent purchasing system 100 may be configured to provide an interface including outcomes based on the user's request as well as other potential outcomes based on one or more requests recommended by the system that may have been derived from collective information.

The operations module 136, when executed by the processor 118, may cause the processor to receive data at an input and, after processing with other aspects of the digital persona decision system 134, provide an output including, for example, search results or potential outcomes that have been ranked (scored), sorted, weighed individually or together, filtered, or otherwise processed according to a selected one of a plurality of personas 138. The personas 138 may include digital representations of individual consumers, groups of consumers, organizations, other entities, or any combination thereof.

The AI engines 140 can include instructions that, when executed, cause the processor 118 to apply one or more selected personas of the personas 138 to received requests, to results corresponding to the requests, or any combination thereof. The AI engines 140 can cause the processor 118 to process the data according to the selected persona(s) to rank the data, filter the data, or otherwise alter the data to provide a desired result or outcome that corresponds to a particular persona, either based on the request or based on collective information derived from the user, from other users, from other factors (such as yield management rules), or any combination thereof. The AI engines 140 may apply the selected persona to try to determine what the user means or is trying to achieve rather than what the user says he or she means (e.g., to retrieve data corresponding to what the user intends to find). The AI engines 140 may also apply the selected persona to rank, sort, filter, or otherwise process received data. In some embodiments, the AI engines 140 may apply the selected persona(s) to negotiate with a supplier on behalf of the user. Further, the AI engines 140 may be configured to automatically grab a product or service on behalf of the user.

Additionally, the AI engines 140 may include at least one evolutionary function that, when executed, causes the AI engines 140 to process and update a persona over time, based on environmental factors, interactions by a user associated with the persona, interactions of other personas, and so on. In particular, the AI engines 140 may rely on experiential learning over time. In certain embodiments, the AI engines 140 can assimilate numerous interactions by various personas, some of which may be similar to the selected persona, to learn experientially. The experiential learning process may involve analyzing persona interactions (explicit or implicit) with the “universe” of available options to generalize trends and other information, which may be used to adjust the selected persona, other personas, etc., and to make recommendations and assist in decision-making. Further, such interactions may be analyzed to enhance the collective information based on requests, outcomes, interactions, or any combination thereof.

In certain embodiments, the AI engines 140 may include collaborative filtering, clustering, classification, frequent pattern mining, outlier detection, noise reduction, and other functionality implemented via systems that may be implemented using declarative rule-based systems, such as Drools or another rule-based management system. The AI engines 140 may be configured to process data (structured, unstructured, or semi-structured data) by filtering, clustering, classifying, weighing, correlating, performing any of the above-described functions, or otherwise processing the data.

The intelligent purchasing system 100 can learn from data based on the user's response to a set of outcomes; based on other actions, searches, and requests by other users; based on other information; or any combination thereof. The intelligent purchasing system can also learn from the stated preferences in the brain, as updated by the user and the system over time. Further, the intelligent purchasing system 100 can learn from the yield management system rules and the collective information, which may be impacted by other parts of the intelligent purchasing system 100.

The intelligent purchasing system 100 may update or modify the yield management system (YMS) rules via the yield management system (YMS) 146. The YMS 146 can periodically or continuously analyze inventory data and changes related to the inventory data. When changes to the inventory data occur, the intelligent purchasing system 100 can modify the rules to account for the changes. For example, the YMS 146 may determine that price changes and inventory availability may be updated at particular times, and that lower prices tend to be offered at particular times and days, and the YMS 146 may update the YMS rules accordingly. The intelligent purchasing system 100 can utilize the new YMS rules to provide the user with the “best” options. Additionally, the YMS 146 may be configured to communicate with the AI engines 140 configured with selected personas 138 to make recommendations, to identify potentially expiring inventory, and to assist the user in configuring the one or more parameters.

In some embodiments, the intelligent purchasing system 100 may try to determine the “best” options for the user or the persona. The “best” options may not be based solely on what a user says he or she wants (i.e. in a request), but may refer to options that he or she actually wants. A concept of “best” or “better” may encompass one or more factors (including a large number of factors) defined by the user, suggested by the intelligent purchasing system 100, or both. Thus, the “best” options may provide the user with beneficial outcomes he or she may not have thought of. For example, in the context of travel, the intelligent purchasing system 100 may present a user with two flight options: option A and option B. Option A and option B may be the same price, but option B may include a stop in New Zealand. While the intelligent purchasing system 100 may know that user normally prefers non-stop flights, the system 100 may also know that the user has a friend or business contact in New Zealand, and that New Zealand is a top travel destination in the user's wish list. The intelligent purchasing system 100 may determine that even though the user typically prefers non-stops, the “best” search results can include a stop in New Zealand. In some embodiments, based on further information, such as business schedules, birthdays, or other information, the system 100 may know that on this occasion having a stop in New Zealand may be better for the user.

In another travel example, the intelligent purchasing system 100 may determine that “best” may not always the cheapest option, but may instead be purchased using a combination of cash or airline miles. For tickets purchased with airline miles, the intelligent purchasing system 100 can take into account how many mile points (or credits) the user has on different carriers; availability to use the mile points to pay for a particular outcome (e.g. one way/round trip/flexible dates/flexible cities); cost of miles on different airlines; different dates (including the value of a mile point at any point in time as compared to cash); taxes and processing fees on different airlines; other factors (e.g., non-upgradeable mileage ticket vs. potentially upgradeable cash ticket); other options; or any combination thereof. Better possibilities may include mileage options from one carrier, options made up of segments from multiple carriers, or a combination of miles and cash on one or more carriers. In certain embodiments, the intelligent purchasing system 100 may grab the “best” option on behalf of the user.

While the above-examples have largely been directed at travel, in some embodiments, the intelligent purchasing system 100 can provide and grab the “best” results for non-travel products. For example, a user may want to buy a refrigerator. The intelligent purchasing system 100 may determine a “best” outcome based on product specifications, price, reviews, factory recalls, other users' purchasing behavior, or other parameters, and not solely based on a model number input by the user. Examples of outcomes may include whether a product is new, used, a demo model, refurbished, discontinued, etc. In some cases, the outcomes can include whether the product is being sold as a result of a close out or liquidation. Further, the outcomes can include the product's country of manufacture, warranty terms, installation costs, shipping costs, removal costs, or taxes. In some embodiments, the outcomes can include whether a purchase would take advantage of any holiday promotions, tax-free weekends, seasonal promotions, and so forth. The outcomes may include other parameters not listed.

Finding the “best” outcome may be achieved based on multiple factors including: what users say they want; what they subconsciously want; what their decisions demonstrate they want; what their activities using the system demonstrate they want; what people they trust want and recommend; what experts recommend; financing; other factors; or any combination thereof. The systems and processes described herein may weigh these and other factors (both structured and unstructured) across an entire range of actors and behaviors, and then the systems and processes described herein can prioritize the factors to provide results that are precise and comprehensive and that are aligned with what the user wants. When a product or service is identified that meets the user's or persona's parameters, the intelligent purchasing system 100 may grab the product or service automatically on behalf of the user.

The process of finding the “best” outcome can include implementing digital personas as described herein. A digital persona can be a digital representation of an entity in accordance with a specific set of rules, preferences, or priorities with respect to a defined situation or opportunity. A digital persona 138 may interact with a universe, which can be a set of conditions and information that an artificial intelligence engine implementing the digital personas can perceive at any given moment. The digital personas can learn, via the artificial intelligence engine, from actions of a user, events in the universe, other personas, a multitude of other factors, or any combination thereof. In some examples discussed, the artificial intelligence engine 140 may include a persona artificial intelligence engine and an evolutionary artificial intelligence engine.

As used herein, a digital persona, such as a persona in the digital personas 138, can be a digital representation of an entity (a human, corporation, group, etc.). A digital persona can be a digital representation of a virtual being or a real being that has a set of preferences or rules in relation to a certain problem. An entity may be a depiction of a virtual or real being that has a set of preferences, weights or tendencies in relation to a certain problem. A potential solution may be a solution to a problem that may or may not relate to the priorities of a corresponding digital persona. In certain embodiments, a potential solution may represent a potential option that may be selected to satisfy one or more of the digital persona's needs or solve their problem. A chosen or selected solution can be at least one of the potential solutions that, by way of weighing, was chosen to be appropriate (or most appropriate) to solve the problem or that was determined, based on scoring, to be the most satisfactory to the digital persona.

An engine can be a software mechanism that can process several tasks: such as reading digital persona preferences; obtaining a list of potential solutions; combining competing personas into a unified persona; selecting between competing personas to identify a subset of possible solutions; and determining optimal solutions with respect to specific situations. Priority can be a way to show a preference in relation to other preferences so as to allow the engine to weigh an impact of a preference on the overall score. An entity may be a human, corporation, or group that may have preferences with respect to a certain problem, a set of products, a scenario, a situation, or any combination thereof. An entity may either be virtual or real. The entity may represent a virtual entity, a person, a certain facet of a person (e.g., the user as a business person vs. the user as a family person), or a surrogate (e.g. an entity acting on behalf of an employer, a parent for a child, a guardian in a custodial relationship, a trustee on behalf of a beneficiary). A parameter may be a specific set of rules, preferences, and priorities established by a user of a digital persona with respect to a defined situation or opportunity to decide among varied options.

A digital persona refers to a snapshot of information captured about a user, by an artificial intelligence of any sort, e.g., machine learning, neural networks, evolutionary/genetic algorithms or other sorts, or a combination of some or all of these, to represent the preference and decision-making process of a represented entity at a point in time (given the universe of available options) and over time (given a plurality of decision-making opportunities). The digital persona can be used to mimic, replace, supplement or otherwise enhance human or other entity behavior. The digital personas may be the personas 138, and may be included in the digital persona decision system 134.

The intelligent purchasing system 100 and methods described herein may utilize personas to provide a personalized experience for a user in almost any commercial sector. The personas can operate to provide a reactive system that reacts to user queries and requests; and a proactive system that anticipates problems, needs, issues, etc. and that may take steps (without user input) to mitigate or solve those problems, needs, and issues, etc. or to coach the user how to do so. The combination of reactive and proactive aspects may provide a dynamic, constantly learning and evolving system that can always operate (e.g. twenty-four hours a day, seven days a week), that does not need to rest, and that can assist the user in a myriad of ways (sometimes without the user being aware). Some examples provided herein reference the travel industry sector, which may be a good example of how the systems herein can provide valuable insights and decision-making capabilities; however, the travel sector may be only one of many different sectors in which the systems and processes herein can be implemented. Such decision-making capabilities may include the ability to decide to grab (hold or purchase) a product or service on behalf of a user and without explicit user instruction to do so.

The digital persona decision system 134 can include a selector/optimizer component 144 that, when executed, causes the processor 118 to select between available results and to provide selected results to an output, such as a graphical user interface to be presented within an Internet browser application running on a computing device associated with the user. In certain examples, the selector/optimizer component 144 may be presented with multiple sets of search results, which may have been sorted, filtered, ranked, or otherwise processed by the AI engine 140 applying multiple selected personas 138. In an example, the results may be sorted, filtered, ranked, or otherwise processed using one or more selected personas from personas 138 to provide search results ranked across multiple parameters according to each of the selected personas, and the selector/optimizer component 144 may select one of the sets of ranked search results for providing as an output. In certain embodiments, the selector/optimizer component 144 may operate on opportunities, problems, outcomes, and event analysis in response to experiences and activities in the user's life and independent of any user query.

The selector/optimizer component 144 may select between the sets of search results based on data associated with a requesting device. In some examples, the selector/optimizer component 144 may use the YMS 146 to produce a set of search results. Further, the intelligent purchasing system 100 may utilize collective information (such as collective information 114 in FIG. 1), which may be determined by the machine learning engines 141, the AI engines 140, the YMS 146, or any combination thereof. The intelligent purchasing system 100 may utilize the collective information 114 to suggest other searches to the consumer, which other searches may have previously produced “better” or “best” outcomes based on a similar request. In some embodiments, the intelligent purchasing system 100 may suggest searches or may suggest things to buy and ask for permission to do so (i.e., authorization to grab particular products automatically on behalf of the user).

In the context of a “grab” operation, the intelligent purchasing system 100 may receive a set of parameters defining a product or service of interest to the user. The intelligent purchasing system 100 may analyze the received parameters in light of the YMS rules and may suggest potential changes to the user. For example, if prices may be lower on particular days (e.g., a Saturday night stay reduces the price for a hotel room), the system may suggest adjustments to the parameters to potentially enhance the value to the user. In the context of a dwindling inventory item, the system may also suggest that the user authorize the AI engine 140 to automatically grab the product or service on behalf of the user if the product or service is found that meets the parameters defined by the user or the persona.

The collective data may include data based on an averaging of outcomes and interactions with such outcomes of multiple users. In some cases, the collective information can include search data and results data from other requests that are similar or identical to the request submitted by the user. A distribution of requests and search results can be analyzed to determine overall trends of requests and search results and to identify requests, phrases, and techniques that produce better outcomes. In some examples, the collective information may include information about how often users initiate a secondary search, whether users buy products or services after receiving search results, which products or services are bought for business or leisure, or other information. In some embodiments, the collective information may include data about where a product was found on attractive terms, particularly (but not exclusively) as compared to products that would have been expected. For example, the collective information may include data about a “great deal” that was unearthed.

In an embodiment, the intelligent purchasing system 100 may be configured to grab a package or suite of products or services on behalf of the user. In an example, the package may include a trip package, such as airline tickets, accommodations, car rental, and a pair of event tickets. In another example, a package may include a “romance” package that may include chocolate covered strawberries, champagne, accommodations, other related items, and so on. The intelligent purchasing system 100 may grab a package on behalf of the user.

In some embodiments, the intelligent purchasing system 100 may also understand time sensitivity and may be configured to prioritize or potentially to hold a product while compiling a presentation of it (for marketing to one or more users) or while waiting for a decision from a particular user. This type of grab operation may include placing a hold on the product or service and communicating with the user or persona via digital messages, phone calls, emails, voice and so on to acquire authorization to complete the transaction. The inventory handled by the yield management system 146 may periodically or continuously change as new data related to products or services are received, search result trends change, other information is received (updated by experts or as a result of analysis of third party data, such as news, trends, and so on), or any combination thereof. In some cases, the yield management system 146 may be updated in real time. For example, the yield management system 146 may be continuously updated with information that was retrieved by a bot application.

In certain embodiments, the selector/optimizer component 144 may select the “best” outcomes or best searches in response to experiences and activities in the user's life (and in some instances independent of any user query), proactively providing a best representation of the possible outcomes according to the available information about the user as represented by a persona and according to available inventory (identified using request information from the user, request data derived from collective information, or both) at that point in time. For example, the selector/optimizer 144 may identify and select the “best” search or results based on a ranking of the user's persona(s) preferences (e.g., non-stop flights are more important than price). In certain embodiments, the computing system 102 may implement a set of digital personas that compete among themselves to resolve a problem or to respond to a request in order to identify one or more outcomes that may best mediate the variable interests of the user of the digital personas. By allowing the multiple digital personas to impact the search and the processing of the results, the computing system 102 may produce multiple, varied search options or outcomes, which can be compared and optionally processed by the selector/optimizer component 144. In certain embodiments, the selector/optimizer component 144 may select between the competing results or may selectively combine results from the competing search options or outcomes. The computing system 102 thereby may identify a plurality of potential options that may be better or best for the particular user.

In some cases, the computing system 102 can produce “better” or “best searches and outcomes in less time using a system of ontology. Ontology can be a system of standard vocabulary that can be applied to products, services, inventory, events, or other parameters. Examples of standard vocabulary can be airport codes (e.g., ABIA, EWR, DFW, etc.), mattress sizes (e.g., full, queen, king), and so forth. The computing system 102 may determine names and descriptions that can be applied to disparate inventory and event sources. For example, the computing system 102 may determine which cars fall into compact, standard, or luxury classifications by processing data collected from rental car companies. In certain embodiments, the system 102 may normalize received data where the data is inconsistent and may identify true value of a product where data descriptions are misleading. In a particular illustrative example, the system 102 may be configured to understand that a Ford® Focus® labeled as a sport utility vehicle (SUV) is mislabeled, and determining that the true value of such a vehicle to someone requesting an SUV would be minimal.

In some embodiments, the yield management system 146 may be represented as being included in the selector/optimizer component 144. In other embodiments, the yield management system 146 may be part of the AI engine(s) 140 or combined with other components of the digital persona decision system 134. In certain embodiments, the yield management system 146 may communicate with the AI engines 140, causing the AI engines 140 to communicate recommendations regarding the selected parameters to improve likelihood of success. Further, in some embodiments, the yield management system 146 may communicate the user's or persona's parameters to one or more suppliers 108, enabling the suppliers 108 to offer a product or service that meets the user's needs. If a supplier offers such a product or service, the system 100 may automatically grab the product on behalf of the user.

In some embodiments, a user or a persona associated with a user may configure at least one parameter corresponding to a product or a service of interest to the user or of interest to a group of users. The system may be configured to identify a product or service that satisfies the at least one parameter and may automatically grab the identified product or service on behalf of the user or may automatically grab identified products or services on behalf of the group of users.

In an example, a user may purchase an inventory item, such as a flight or a hotel accommodation. After the purchase, the intelligent purchasing system 100 may continuously search for better options, which may satisfy the user's travel requirements and that may better suit the user's preferences (e.g., later departure time, earlier arrival time, fewer stops, better price, upgraded class, and so on). In the case of a hotel accommodation, a better option may include an upgraded room for the same rate, meal vouchers, bonus reward points, and so on. Other “value adds” may also influence the determined overall value. The intelligent purchasing system 100 may automatically grab the better option on behalf of the user.

In some embodiments, the computing system 102 may provide an interface to a computing device 114 through the network 104. The interface may include one or more user-selectable elements, such as text fields, check boxes, pull-down menus, radio buttons, other elements, or any combination thereof, which elements may be accessed to configure a plurality of parameters to define an option or service of interest to the particular user. The user may configure the interface and submit the information to the computing system 102. In response to receiving the information, the system 102 may automatically grab a product or service on behalf of the user. In some embodiments, the system 102 may search one or more data sources to identify one or more options that correspond to the parameters, determine a “best” option from the one or more options, and “grab” the identified option on behalf of the user.

In another embodiment, the computing system 102 may provide a search interface including one or more user-selectable elements that may be accessed by the user to initiate a search for a particular product or service. The system 102 may retrieve a plurality of options that satisfy the search terms, and may selectively rank the plurality of options. The system 102 may also communicate parameters specified by the user to one or more suppliers, who may respond with a qualifying offer. The user may review the options and may configure one or more selectable options within the interface to empower the computing system 102 to search for “better” options and to automatically “grab” a “better” option if one is identified. The system 102 may continue searching, may rank identified options, may compare them to the parameters (or to a previously purchased option), and may automatically grab a “better” option on behalf of the particular user. Other embodiments are also possible.

While the above-discussion focused on identifying and grabbing an option on behalf of a single user or persona, the intelligent purchasing system 100 may also operate on behalf of a group of users. For example, in a group travel context where multiple group members may be traveling to a common destination, the intelligent purchasing system 100 may be empowered to automatically grab an option on behalf of a particular user by purchasing the option, and may be empowered to grab an option on behalf of a second user by holding the option and communicating with the second user to acquire authorization to complete the transaction.

Additionally, the system 100 may communicate data related to the parameters to one or more suppliers to provide leads that may enable a supplier to provide a matching offer. The intelligent purchasing system 100 may be configured to grab such an offer to complete the transaction on behalf of the user. Additionally, the system 100 may continue searching for “better” options and may continue to look for options that meet the user's parameters. If a better option is identified, the system 100 may automatically grab the better option on behalf of the user.

In some instances, the intelligent purchasing system 100 may determine that no product matches the user-defined or persona-defined parameters. In some embodiments, the intelligent purchasing system 100 may recommend changes to the user-defined or persona-defined parameters based on yield management rules, based on best available offers, or based on other criteria to assist the user in identifying a product or service that meets his or her needs.

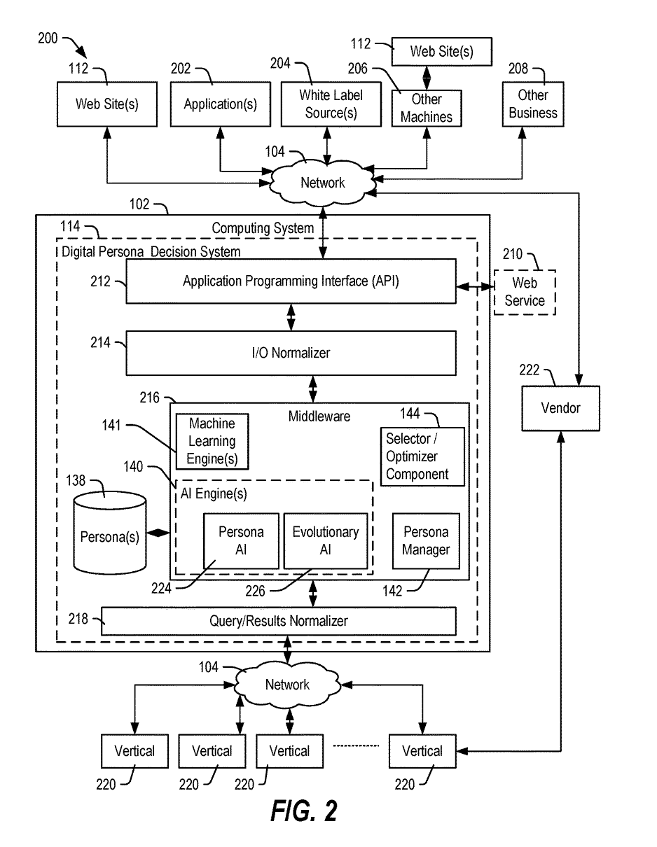

FIG. 2 depicts a block diagram of an intelligent purchasing system 200, in accordance with certain embodiments of the present disclosure. In some embodiments, all of the functions of the computing systems as described with respect to FIG. 1 can be performed by the system 200. The intelligent purchasing system 200 can implement providing “better” or “best” searches on behalf of a client either at a time that a request or initial search is received or after an initial search has been completed and can automatically grab the “best” option on behalf of the user. Better searches lead to better results. The “better” or “best” search may be based on a client's query, desired outcome or outcomes, previous search results (collective information from decision-making of other users), yield management rules, group search results, other data, or any combination thereof. In some cases, the “better” or “best” search results may be determined by artificial intelligence engines 140, a selector/optimizer 144, a yield management system 146, other components, or any combination thereof.

The computing system 102 may be configured to communicate with web sites 112, applications 202, white label sources 204 (i.e., private label applications or services), other machines 206, a web site 112 through one of the other machines 206, other business 208, vendors 222, or any combination thereof, through a network 104. Additionally, the computing system 102 may be coupled to one or more verticals 220 through the network 104. The term “vertical” may refer to a particular market sector, such as travel, financial, healthcare, real estate, entertainment, education, military, retail, grocery and produce, employment, etc. Each of the verticals, identified by 220, may include a plurality of websites, businesses, etc. that service that particular sector. Though each of the verticals 220 is depicted as distinct, it should be understood that the verticals 220 overlap one another and that a business entity or website may cross multiple verticals, or sub-categories within one or more verticals (sub-verticals).

The computing system 102 can include the digital persona decision system 134. The digital persona decision system 134 may include an application programming interface (API) 212, which may be coupled to the web sites 112, applications 202, white label sources 204, other machines 206, other businesses 208, web service 210, vendor 222, or any combination thereof. The web service 210 may be part of the computing system 102 or may be associated with another device or system. The API 212 coordinates interactions between the computing system 102 and external components, devices, applications, etc. Further, the API 212 may receive data from the network 104 and may provide the data to an input/output (I/O) normalizer 214.

The I/O normalizer 214 can translate received data into a format suitable for processing by the middleware 216. In certain embodiments, the I/O normalizer 214 may perform extract, transform, and load (ETL) functions using artificial intelligence. In particular, the I/O normalizer 214 may extract data from a received data stream, transform the data into appropriate formats (e.g., transform date information in a form of m/d/yy into a form mm/dd/yyyy), and load the data into a temporary table, which may be provided to the middleware 216. The normalization process may be performed automatically by a machine (the I/O normalizer) and may only utilize a minimal “mapping” effort with respect to placement of the data into the table.

The middleware 216 may include the selector/optimizer component 144, the machine learning engines 141, the AI engines 140, the YMS 146, and the persona manager 142. The persona manager 142 may receive data from the I/O normalizer 214 and determine one or more personas from the personas 138 for use in connection with the received data. Additionally, the persona manager 142 may cause the processor to selectively execute a persona AI engine 224 (which applies selected personas to data), an evolutionary AI engine 226 (which may initiate changes in selected personas based on client interactions with the data, based on information derived from other personas, based on information derived from the “universe” of options, or any combination thereof), or a hybrid of both. The computing system 102 may further include a query/results normalizer 218, which may normalize a query, data, other information, or any combination thereof into data formatted for a particular one of the verticals 220.

Further, in some embodiments, the AI engines 140 may continue to search for “better” options, even after a purchase has been made. Further, the AI engines 140 may grab a “better” option if the option fits the criteria established by the user or if the “better” option would be better in terms of an attribute that would be appreciated by the user. In an example of the latter instance, if the AI engines 140 identify the same item for a lower price and can save the user money by grabbing that item after taking into account cancellation fees or change fees on the first item, the AI engine 140 may be configured to do so on the user's behalf and to refund the difference. Other embodiments are also possible.

In an example, a user (or persona) may submit, to the computing system 102, one or more parameters defining a product or service of interest to the user (or persona). The parameters may be submitted via a computing device operated by a user or operating autonomously, such as by operation of an artificial intelligence agent. The parameters may be received via a natural language input (e.g., voice) and may be converted to text and processed to determine the parameters. In response to receiving the parameters, the API 212 may provide the parameters to the AI engines 140 to determine one or more products or services that correspond to the parameters. The AI engines may rank the one or more products or services according to a determined value to the user (or persona) and may automatically grab one of the products or services on behalf of the user (or persona) where the one satisfies the one or more parameters. Further, the AI engines 140 may automatically communicate the parameters to one or more suppliers to allow a supplier to make an offer.

In another example, a user (or persona) may initiate a query via the web site 112, a mobile application, a business-to-business (B2B) connection, or any other front end device or system, and the query may be submitted to the computing system 102. The client may be a computing device operated by a user or operating autonomously, such as by operation of an artificial intelligence agent. In some embodiments, as the user inputs the query into a field of the web site 112, the API 212 may access collective information to determine if other terms or queries might achieve better outcomes corresponding to the user's query. In some embodiments, the API 212 may suggest one or more changes to the query before the query is submitted in order to improve the retrieved outcomes. Better searches produce better outcomes.

In some embodiments, the API 212 can receive the query and may provide the query to the I/O normalizer 214. The I/O normalizer 214 can process the query into a suitable format for the middleware 216. The API 212 or the normalizer 214 may process the query to determine a vertical that corresponds to the query. One or both of the API 212 and the normalizer 214 may include a plurality of instruction sets. Each instruction set can be selectable to “wrapper” the query and to apply the query to the vertical. The wrapper may both format the query for a particular supplier and direct the system 102 to conduct the search via a particular supplier (i.e. where to send the data, how to send the data, etc.). In some embodiments, one or both of the API 212 and the normalizer 214 may utilize collective information to identify “better” or “best” searches, which may yield better outcomes.

The middleware 216 may select one or more personas from personas 138 using the persona manager 142. The middleware 216 may also apply the selected persona(s) to the query using the persona AI engine 224 to perform query expansion, apply modifications or corrections to the query, and add constraints and refinements to the queries according to a selected persona to customize the query to the selected persona. The middleware 216 may provide the processed query to the query/results normalizer 218, which may format the processed query for a particular vertical 220. The query/results normalizer 218 may then provide the wrapped query to one or more data sources associated with the vertical 220.

In response to the processed and normalized query, the computing system 102 may receive results associated with one or more products in the particular vertical. The query/results normalizer 218 may receive results from multiple data sources and may extract, transform, and load the results into one or more temporary tables, which may be passed to the middleware 216. The persona AI engine 224 may apply one or more selected personas from personas 138 to the results to produce one or more processed results. The processed results may be ranked, sorted, weighed, filtered, processed, or any combination thereof according to each of the one or more selected personas, potentially producing multiple multi-dimensional sets of processed results, which may be provided to the selector/optimizer component 144. The selector/optimizer component 144 may use the YMS 146 to produce a “better” or “best” representation of results. The selector/optimizer 144 can provide the “better” or “best” results to the I/O normalizer 214, which may extract, transform, and load the data from the selected one of the sets of processed results into a format suitable for the API 212 to provide the results to a destination, which may be a device, an application, a web interface, etc.

By applying collective information to a received query, a better or best search may be constructed, which may produce better outcomes. Better searches produce better results. In some embodiments, the API 212 may provide the results of the received query as well as an option to review results from one or more other queries determined from the collective information.

In some embodiments, the I/O normalizer 214 may normalize the input and provide the input to the middleware 216. The middleware 216 can deliver specific facts and circumstances at hand to a persona AI engine 224 with selected digital personas from the personas 138, where each of these selected digital personas offers a potential solution in accordance with the following process: (1) the computing system 102 can produce a solution aligned with specific preferences and restrictions pre-established by the client within each digital persona; (2) the system 100 can conduct a competition among the digital personas to determine optimal solutions for the client in the context of the specific facts and circumstances of each client request; and (3) the system 100 can resolve the problem presented by the client of the digital persona.

The selected digital personas may be applied to the persona AI engine 224 to customize the persona AI engine 224, which customized AI may process the input data to adjust keywords, apply restrictions and query enhancements, and produce queries that are aligned with the specific preferences and restrictions associated with that particular persona. Such preferences and restrictions may be configured by a client, may be learned over time from explicit and implicit feedback from the client's interactions, may be inferred from interactions of various personas, or any combination thereof. The queries produced by the persona AI engine 224 based on each of the selected personas may be normalized by query/result normalizer 218 and may be sent to one or more data sources. The system 100 may receive results corresponding to each of the normalized queries, and the results from each of the queries provides a basis for competition among the digital personas, which competition may be resolved by the selector/optimizer component 144 to determine optimal solutions for the particular problem. The results may be normalized by query/result normalizer 218 and provided (together with the associated persona) to the selector/optimizer component 144, which may select between the results or which may selectively combine the results from one or more of the sets of results to produce a set of search results. In certain embodiments, the persona AI engine 224 may be configured to automatically grab the “best” option on behalf of a particular user.

In some embodiments, using the collective information, the API 212 and the I/O normalizer 214 may cooperate to analyze the received query against collective information to identify better terms or other better searches that can produce better outcomes corresponding to the request. In an example, the API 212 and the I/O normalizer 214 may produce a “better” search and may present the results of the better search as a selectable option within the web page so that the user may review his/her search results or review results from a “recommended search.”

In some cases, the search may be configured, based on collective information, to produce outcomes that may be more valuable to the consumer than other options. In some embodiments, where rules apply, the system 102 may check two one way travel options or may check a travel option having a stay over with a Saturday night stay or leaving on a Tuesday rather than a Thursday. The system 102 may develop experience with yield management rules as well as routine price variations over time (based on real world sense checking, adding search variations, etc.), and may determine that such variations can provide better results based on the yield management rules.

In certain embodiments, the computing system 102 may recognize a particular persona as being an “expert” based on “successes”, where “success” may be defined based on a “purchase” or some other factor. Such experts may be recognized within the computing system 102 based on such information, whether or not that person may be recognized as an expert elsewhere or in any other context. In some embodiments, an expert may be determined based on a user consistently finding low prices, preferred routes, better deals, etc. In certain embodiments, the persona may be a “celebrity” or “expert” persona, such as an Einstein persona, which could be an expert persona with respect to a certain subject area. Further, the computing system 102 may recognize a “trendsetter” based on the client's ability to make choices, over time, that may be unpopular at the time the choice is made, but that becomes popular shortly after the trendsetter's decision was made. That persona, over time, may be identified as a trendsetter.

Throughout the process, the computing system 102 can intelligently track, collate, analyze, and record each solution, monitor client feedback (explicit and implicit), and thereby continuously learn the habits and behaviors of the client of the digital personas. The learned habits and behaviors may be used by the evolutionary AI engine 226 to refine the digital persona over time to achieve ever-more-effective results.

In certain embodiments, the systems described herein may provide group intelligence by combining clients' experiences, choices and results (through groups of personas) to apply such experiential information to future searches. The collective information may be applied at the time the search terms are entered, after the search terms are submitted, while the outcomes are being processed for presentation to the destination device, after the interface including the outcomes is transmitted to the destination device, or any combination thereof.

In some embodiments, a user may access a web page provide by the computing system 102 to configure at least one of a search and a plurality of parameters corresponding to an option of interest to the user. In response to this data, the computing system 102 may be configured to automatically grab an option on behalf of the user, provided the option is better than a prior search result, better than a prior purchased option, or at least satisfies the plurality of parameters. In some embodiments, the system 102 may be configured to grab products or services that are best for the user. For example, the computing system 102 may automatically grab a discount or certificate to a restaurant frequented by the user. Other embodiments are also possible.

With respect to a group, the system 102 may be configured to identify one or more options for each user of a group of users and may automatically grab a selected option for one or more of the users of the group of users. If an option is not available that satisfies the one or more parameters, the system 102 may communicate the parameters to a supplier and may receive an offer corresponding to the parameters. If the offer satisfies the parameters, the system 102 may automatically grab the option on behalf of the user. Otherwise, the system 102 may communicate data related to the option to the user to allow the user to elect whether to accept the offer. Other embodiments are also possible.

In a particular embodiment, the system 102 may be configured to automatically grab a product or service on behalf of the user based on a persona associated with the user and without user input. In an example, a user may make a trip to a particular area over Labor Day weekend every year. The system 102 may automatically determine the pattern of the user's travels, and may grab a “best” option on behalf of the user in anticipation of the user's purchase. The system 102 may operate continuously and over a period of time to grab various options on behalf of the user. In certain embodiments, the system 102 may grab products in different verticals substantially simultaneously like a digital shopping cart or over time, depending on the circumstances and depending on the product or service.

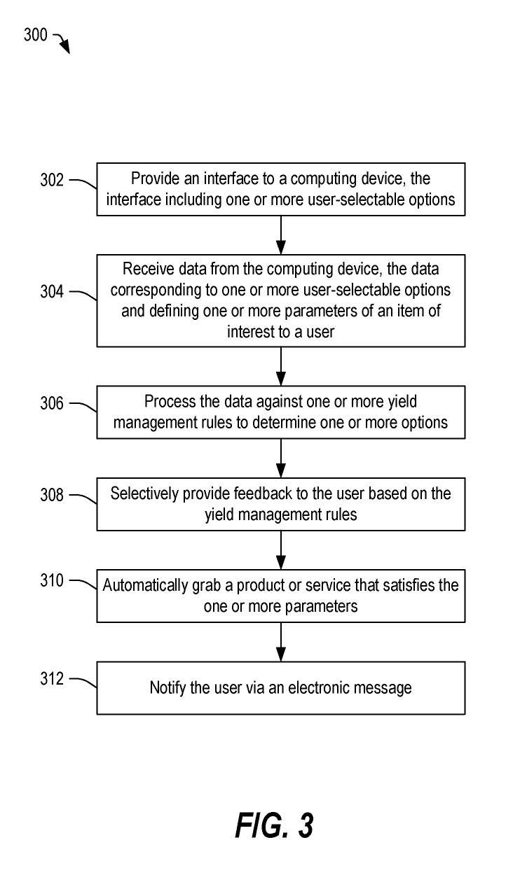

FIG. 3 illustrates a flow diagram of a method 300 of automatically purchasing or holding a product on behalf of a user, in accordance with certain embodiments of the present disclosure. At 302, the method 300 may include providing an interface to a computing device, where the interface includes one or more user-selectable options. Such options may include pull-down menus, text fields, check boxes, radio buttons, buttons, selectable links, slider bars, other elements, or any combination thereof. In some embodiments, the interface may allow a user to upload an audio file, a scanned image, another type of file, or any combination thereof.

At 304, the method 300 may include receiving data from the computing device, where the data corresponds to the one or more user-selectable options and defines one or more parameters of an item (product or service) of interest to a user (or persona). The data may include dates, dollar amounts, product name, other identifiers, or any combination thereof. Further, in some embodiments, the number and type of the parameters is limited only by the user's imagination.

At 306, the method 300 can include processing the data against one or more yield management rules to determine one or more options. The YMS rules can include determining when prices are likely to change for a particular product, determining when supply of a particular product is dwindling, and so on. Further, the YMS rules can identify products that will likely meet the received parameters. In an example, a user may empower the system to grab a product or service that meets the parameters by a particular deadline. However, if the deadline falls on a Sunday, and the prices typically fall on Mondays, the system can determine information about the parameters that can be used to provide feedback.

At 308, the method 300 may include selectively providing feedback to the user based on YMS rules. In an example, if the parameters include a date restriction that may prevent a suitable product or service from being identified, the system may send a message to the user suggesting an adjustment to one or more of the parameters to facilitate identification of a suitable product or service. For example, if YMS rules indicate that pricing for a product typically changes on Tuesday morning, but the user requested that the end date for determining the product be on a Monday, the system may notify the user that better pricing may be had by extending the search window by one day. Other variations are also possible.

At 310, the method 300 may include automatically grabbing a product or service that satisfies the one or more parameters. In an example, the system may grab the product or service that is determined to have the best value for the user. Other embodiments are also possible.

At 312, the method 300 can include notifying the user via an electronic message. The notification may be a text message, an automated phone call, an email, another type of message, or any combination thereof. In some embodiments, the system may notify the user that the purchase was completed. In some embodiments, the system may notify the user that the product or service has been held or reserved for the user, and may request the user to authorize the system to complete the purchase. Other embodiments are also possible.

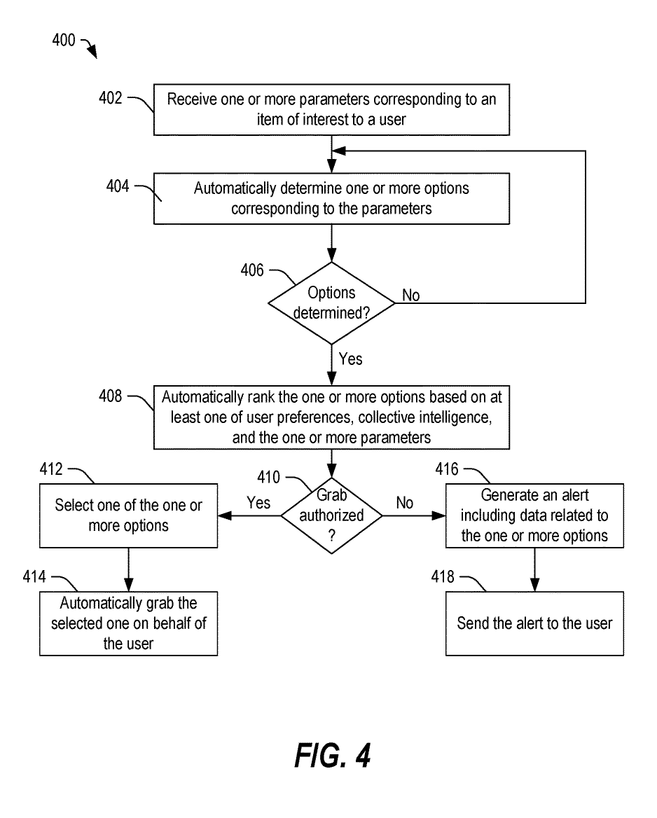

In some instances, when the system does not find an option that satisfies the one or more parameters, the system may continuously search to identify a product or service that meets the parameters. One possible example of a method of continuously searching is described below with respect to FIG. 4.

FIG. 4 depicts a flow diagram of a method 400 of automatically grabbing a product on behalf of a user, in accordance with certain embodiments of the present disclosure. At 402, the method 400 may include receiving one or more parameters corresponding to an item of interest to a user. As discussed above, the one or more parameters may be received from a voice input (speech-to-text conversion), a web form input, a faxed input, an AI engine, a persona, another source, or any combination thereof.

At 404, the method 400 may include automatically determining one or more options corresponding to the parameters. The system may automatically generate a search and may search one or more data sources based on the parameters. Further, the system may utilize YMS rules to determine available inventory. Additionally, the system may communicate data related to the parameters to one or more suppliers as lead generation possibilities, and the system may receive offers from the one or more suppliers in response to the data. Other embodiments are also possible.

At 406, if no options were determined, the method 400 may return to 404 to automatically determine one or more options corresponding to the parameters. This loop may be repeated any number of times, continuously or periodically, until an option is found or until a period of time has expired (such as a closing date window specified in the parameters).

At 406, if one or more options were determined, the method 400 may include automatically ranking the one or more options based on at least one of user (persona) preferences, collective intelligence derived from a plurality of users over time, and the one or more parameters, at 408. The ranking may be based on a determined value of each option relative to the other options.

At 410, the system may determine if the user authorized the system to grab an option. If, at 410, a grab is authorized, the method 400 may include selecting one of the one or more options, at 412. At 414, the method may further include automatically grabbing the selected one option on behalf of the user. In an example, the selected one of the one or more options may be purchased or held on behalf of the user.

Returning to 410, if grab is not authorized, the method 400 may include generating an alert including data related to the one or more options, at 416. The alert may be a text message, an email, a voice message, another indicator, or any combination thereof. At 418, the method 400 may include sending the alert to the user. Other embodiments are also possible.

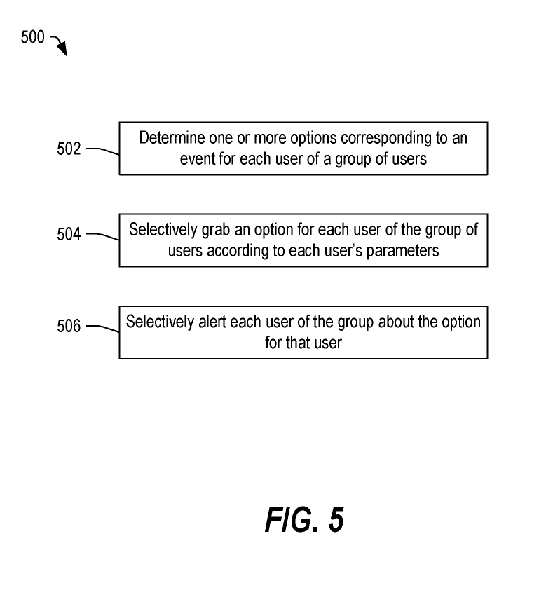

In the above examples of FIGS. 3 and 4, the methods 300 and 400 did not explicitly discuss group interactions. However, the system may perform the same methods with respect to groups of users. In an example, a particular group may have a common travel destination related to a particular event, such as a class reunion, a wedding, or another event. The system may be configured to grab one or more products or services for each user based on the particular user's preferences and authorization. One possible example of a method of grabbing an option on behalf of at least one user of a group of users is described below with respect to FIG. 5.

FIG. 5 depicts a flow diagram of a method 500 of grabbing products on behalf of a group of users, in accordance with certain embodiments of the present disclosure. At 502, the method 500 may include determining one or more options corresponding to an event for each user of a group of users. The one or more options may be different for each user. For example, in the context of arranging flights, some of the users may have different departure dates and times, different departure cities, and so on. Other parameters may also vary, such as the airline, the arrival and departure dates/times, maximum price, and so on. There are no limits to the number of parameters that may be specified by a user (or persona) when defining a product or service of interest to a user.

At 504, the method 500 may include selectively grabbing an option for each user of the group of users according to each user's parameters. In an example, a first user may define an event within the system and may invite one or more other users. The system may automatically send an invitation to each of the other users. Each other user may then visit a website of the system or call a number provided in order to configure his or her parameters. The system may then identify options and selectively grab an option for each user based on his or her parameters.

At 506, the method 500 can include selectively alerting each user of the group about the options for that user. In an example, the system may send a text message to a first user confirming the purchase of a product or service on behalf of the first user. The system may send a phone call to a second user confirming the purchase of a product or service on behalf of the second user. The system may send a text message or a phone call to a third user confirming that a hold was placed on a product or service on behalf of the third user and requesting a decision from the user (either authorization to purchase the product or service or a decision to pass on the product or service). In some embodiments, the system may push data to a mobile application running on the user's phone or may provide interactive voice response services that can be used to notify the user of the available options. Other embodiments are also possible.

In certain embodiments, the system may be configured to identify options for each user automatically and independently from other users. The system may then automatically grab the “best” identified option for a particular user. Further, in the context of the group, the system may determine and grab the “best” identified option for each user. In certain examples, the system may grab each of the options concurrently. Other embodiments are also possible.

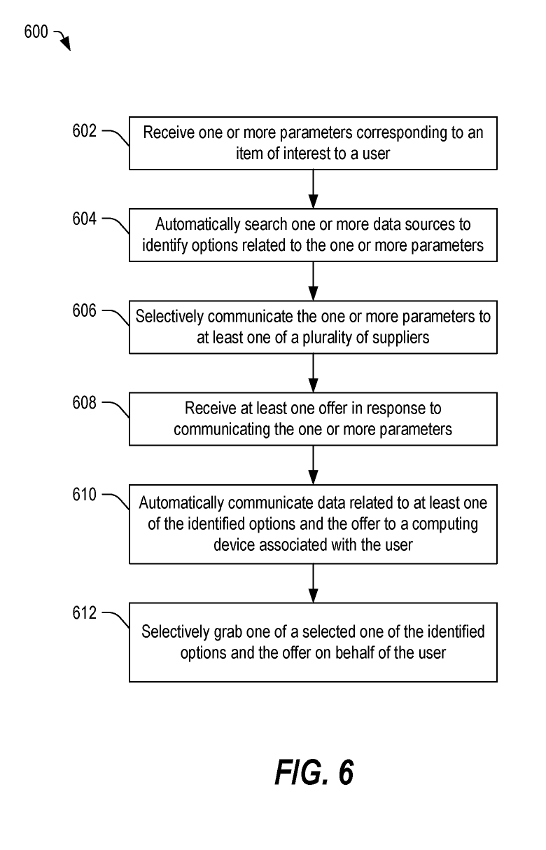

FIG. 6 depicts a flow diagram of a method 600 of grabbing a product offered by a supplier based on parameters of interest, in accordance with certain embodiments of the present disclosure. At 602, the method 600 may include receiving one or more parameters corresponding to an item of interest to a user. The parameters may be received via an email, a voice message, a text, a web form, a mobile application, another source, or any combination thereof.

At 604, the method 600 can include automatically searching one or more data sources to identify options related to the one or more parameters. The method 600 can further include selectively communicating the one or more parameters (or data related thereto) to at least one of a plurality of suppliers, at 606.

At 608, the method 600 may include receiving at least one offer in response to communicating the one or more parameters to the supplier(s). At 610, the method 600 can further include automatically communicating data related to at least one of the identified options and the offer to a computing device associated with the user. The data may include an alert, an interface including the data, a phone call, a voice message, a text message, another indicator, or any combination thereof.

At 612, the method 600 can include selectively grabbing one of the identified options or the offer on behalf of the user. The selected option may be automatically purchased on behalf of the user or may be held pending authorization from the user to complete the purchase transaction. Other embodiments are also possible.

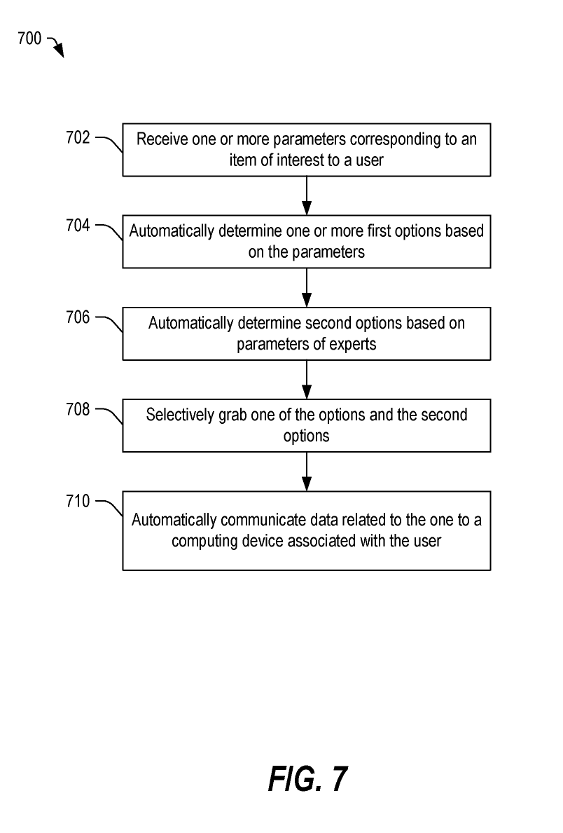

FIG. 7 depicts a flow diagram of a method 700 of grabbing a product corresponding to user parameters or expert parameters, in accordance with certain embodiments of the present disclosure. At 702, the method 700 may include receiving one or more parameters corresponding to an item of interest to a user. At 704, the method 700 can include determining one or more first options based on the parameters.

At 706, the method 700 can include automatically determining second options based on parameters of experts. In an example, the method 700 can include determining search parameters used by users determined by the system to be experts with respect to the particular product or service. In some embodiments, the system may utilize search terms or parameters used by the experts to make recommendations to the user.

At 708, the method 700 may include selectively grabbing one of the first options and the second options. At 710, the method 700 can include automatically communicating data related to the one option to a computing device associated with the user. As discussed above, the system may place a hold on an option and may communicate data related to the held option to acquire authorization to complete the purchase transaction. Alternatively, the system may automatically purchase the option on behalf of the user. Other embodiments are also possible.

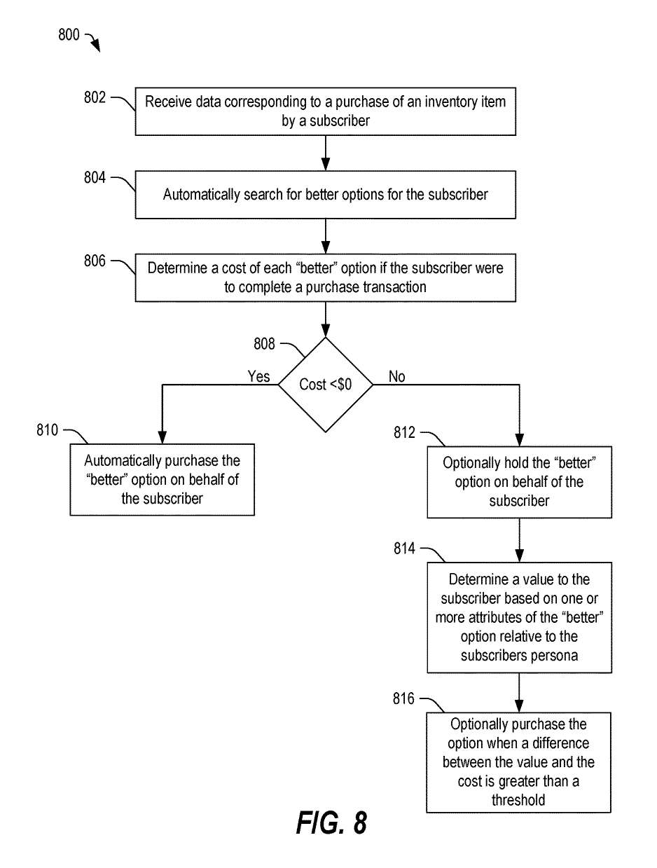

In the above-examples, the parameters for the product or service of interest to the user may be received directly from the user or from a persona. It is also possible to derive the parameters from user interactions with the system, from a purchase made by the user, or from another source. In some embodiments, after the user purchases a product or service, the system may continue to search for better options and may automatically grab a better option, when one is identified. One possible example of such a search is described below with respect to FIG. 8.

FIG. 8 depicts a flow diagram of a method 800 of providing an intelligent purchasing system, in accordance with certain embodiments of the present disclosure. At 802, the method 800 may include receiving data corresponding to a purchase of an inventory item by a user. In an example, the data may be purchase information and a deadline corresponding to an inventory item. In some embodiments, the inventory item may be an expiring inventory item, such as a plane ticket, which may expire when the flight departs, for example, or at a time when it is too late to purchase a ticket. Other expiring inventory items may include concert tickets, performance tickets, other travel arrangements, vacation accommodations, other expiring offers, other items, or any combination thereof. In some examples, the inventory item may be a toy, a product, a service, a device, another item, or any combination thereof. In some embodiments, a deadline for grabbing a particular product or service may be added later, and the user may authorize the system to grab the product or service automatically or to hold the product or service and notify the user.

At 804, the method 800 may include automatically searching for “better” options for the user. In a particular example, at 804, the method 800 may include continuously and automatically searching, even after the user has purchased the item, to try to find a “better” deal for the user. In some embodiments, a better option may be an option that is the same item for a lesser price or for the same price but with options that would be preferred by the particular consumer. In a travel example, a better option may include better departure or arrival times, fewer stops, etc. In another travel example, a business class ticket may be preferred over a coach class ticket at the same price. In another example, a user may prefer a particular airline over another airline, and may be willing to pay a little extra to fly with his or her favorite airline. Other embodiments are also possible.

At 806, the method 800 may include determining a cost of each “better” option if the user were to complete the transaction. In an example involving flight, the cost may include the cost to change the flight with a particular airline. In another example involving a cancellation, the cost may include the cost to cancel a particular option. Other embodiments are also possible. It should be appreciated that the threshold and the comparison may vary from user to user. In some instances, price may be less important as a threshold than timing, particularly when the purchase is for a ticket to attend a particular event.

At 808, if the cost to the consumer of changing from a first option to the “better option” is equal to zero or results in a refund (i.e., is less than zero), the method 800 may include automatically purchasing the “better” option on behalf of the user, at 810. In certain embodiments, the artificial intelligence engine may be configured according to one or more selected personas, which may digitally represent the decision-making of a user. The configured artificial intelligence engine may be configured to determine options that would be “better” for the particular user. In an example, the artificial intelligence engine may identify and purchase a ticket on the same flight as the user's originally purchased ticket and for $200 less. Since the change fee is $100, the user may change to the new ticket and get a refund of $100.

In another example, the “better” option may better fit the user's travel schedule, getting him or her to the destination with adequate time to make it to a scheduled meeting. In such a case, the “better” option may be better for the user, even if it is a little more expensive. In some embodiments, the “better” option may capture upgrades and incentives, such that the user may get a better overall value for the same or less money. Other embodiments are also possible.

At 808, if the cost is greater than zero, the method 800 may include optionally holding the “better” option on behalf of the user, at 812. In an example, the system may grab an option and then communicate the held option to the user (via email or text or an application) so that the user may confirm that he or she wants to purchase the option. If he or she wants it, they can authorize the purchase. In some embodiments, the notification may include a voice notification, a push notification, another type of notification, or any combination thereof.

At 814, the method 800 may include determining a value to the user based on one or more attributes of the “better” option relative to the user's persona. In this example, the artificial intelligence engine may process the attributes of the better option against the preferences of the user (according to the selected persona) to determine when the option constitutes a better option. In some instances, the system may be configured to prompt the user to consider advice from other users that the user trusts. The system may provide an interface through which the user may select a particular user, a network of users, a social group, an expert, someone else's grabbed option or product, or any combination thereof.

At 816, the method 800 may include optionally purchasing the option when a difference between the “real” value of the option and the cost is greater than a threshold. In an example, if the real value is greater than the cost, then the artificial intelligence engine may be configured to automatically purchase the option. Other embodiments are also possible.

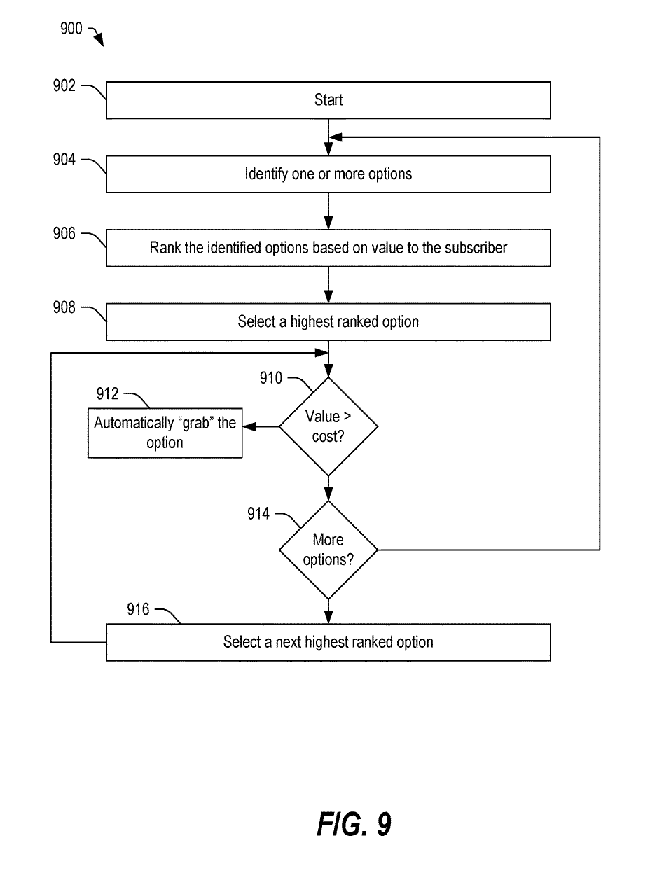

FIG. 9 depicts a flow diagram of a method 900 of automatically purchasing an item on behalf of a user based on a determined value to the user, in accordance with certain embodiments of the present disclosure. At 902, the method 900 may start. Starting the method 900 may include receiving information about a purchase that was already made or about an item (or multiple items) that the user wishes to purchase. In some examples, the information may be received via an email, a phone call, a voice message, an attachment, a web form, text, images, other information, or any combination thereof.

At 904, the method 900 may include identifying one or more options. The one or more options may be alternative options, which may have “better” value for the user. At 906, the method 900 may include ranking the identified options based on value to the user. In an example, the artificial intelligence engine may be configured based on a selected persona, and each option may be evaluated using the persona in order to determine the rank order of the various options based on their attributes.

At 908, the method 900 may include selecting a highest ranked option from the ranked options. At 910, if the value to the user is greater than the cost, the method 900 may include the system automatically “grabbing” the option, at 912. In an example, the system may grab an option by reserving the option electronically for a period of time, by purchasing the option, or by other means. In an example, the system may reserve the option and may immediately contact the user, such as by email, text, phone call, another alert, or any combination thereof to notify the user of the option.

Returning to 910, if the value of the option is less than the cost (as determined by the artificial intelligence engine), the method 900 may include determining if there are more options, at 914. If there are more options, the method 900 may include selecting a next highest ranked option, at 916. The method 900 returns to 910 to determine if the value is greater than the cost.

At 914, if there are no more options, the method 900 may return to 904 to identify one or more options. In general, the method 900 may be repeated continuously or substantially continuously until a deadline expires, such as the departure time of an airline flight, until a grab is made, until a time frame set by the user expires, or until another triggering event occurs.

In some embodiments, the system may automatically communicate data related to the one or more parameters to a supplier, allowing a supplier to create an inventory item to satisfy the user's parameters. If a supplier creates a product or service that satisfies the parameters and sends the offer to the system, the system may automatically grab the offer on behalf of the user.

It should be appreciated that travel represents one possible context to which the systems and methods disclosed herein may be applied to other contexts. In an example, the systems and methods could be used to automatically purchase a book when it is first released, to automatically purchase a new technology, such as a next generation tablet or smartphone, diamond earrings, a wife's birthday present, items in the Black Friday advertising flyer, to purchase other items, or any combination thereof. Further, the system may be configured to purchase multiple products, to purchase products or services on behalf of a group of users, and so on.

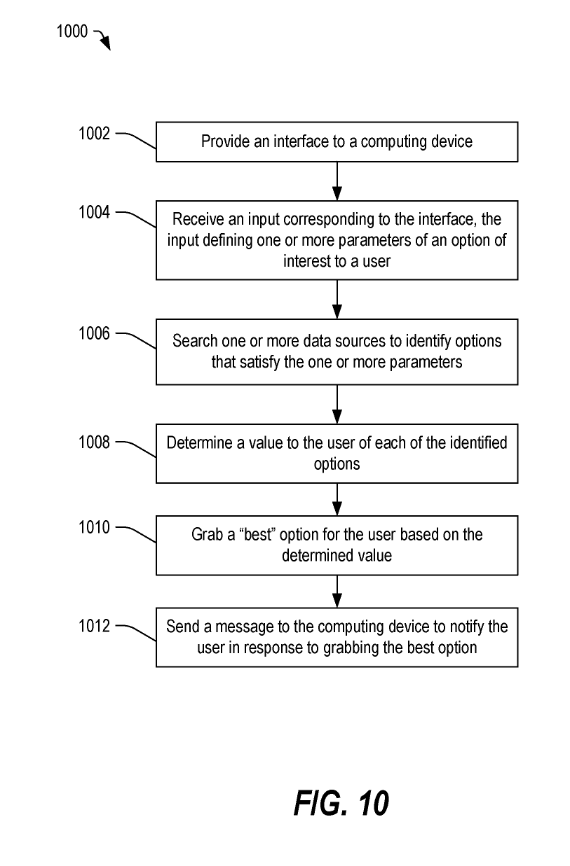

FIG. 10 illustrates a flow diagram of a method 1000 of automatically grabbing an item on behalf of a user, in accordance with certain embodiments of the present disclosure. At 1002, the method 1000 may include providing an interface to a computing device. The interface may be a web page that can be rendered within an Internet browser application executing on the computing device. The interface may include one or more user-selectable elements that can be accessed by a user to configure one or more parameters. In some embodiments, the interface may be an input interface configured to receive text inputs, which may be natural language input from a speech-to-text converter, from another computing device, from a text input, from a document, from another source, or any combination thereof.

At 1004, the method 1000 can include receiving an input corresponding to the interface, where the input defines one or more parameters of an option of interest to the user. The option may be a product or service that the user wishes to purchase, such as a new release book, a concert ticket, a plane ticket, and so on. The parameters may include various attributes that may relate to the particular product and to the user's particular interest. For example, the user may configure the system to purchase a product (such as a new smart phone, a particular book, a concert ticket, etc.) as soon as it comes available. In another example, the user may configure the system to purchase a plane ticket if one comes available for a particular departure city and arrival city around a particular date. In still another example, the input may configure the system to grab a particular product or service if it falls below a particular price. Other embodiments are also possible.

At 1006, the method 1000 may include searching one or more data sources to identify options that satisfy the one or more parameters. In an example, the system may retrieve data related to one or more of the identified options. At 1008, the method 1000 can include determining a value to the user of each of the identified options. The system may automatically determine the value based on user preferences, prior purchases, collective intelligence, social network valuations, expert valuations, and so on.

At 1010, the method 1000 may include grabbing a best option for the user based on the determined value. In a particular example, the system may grab the particular item (such as by adding the item to a checkout) and then may contact the user to authorize the purchase. In another particular example, the system may grab the particular item by purchasing the item automatically. Other embodiments are also possible.

At 1012, the method 1000 can include sending a message to the computing device to notify the user in response to grabbing the “best” option. In an example, the system may text the user to notify the user of the purchase. In another example, the system may initiate a call, email, or text to a communications device associated with the user, such as a computing device. In some embodiments, the notification may be a voice notification. In another embodiment, the notification may be pushed to an application running on the communications device of the user, such as an application corresponding to the system. Other embodiments are also possible.

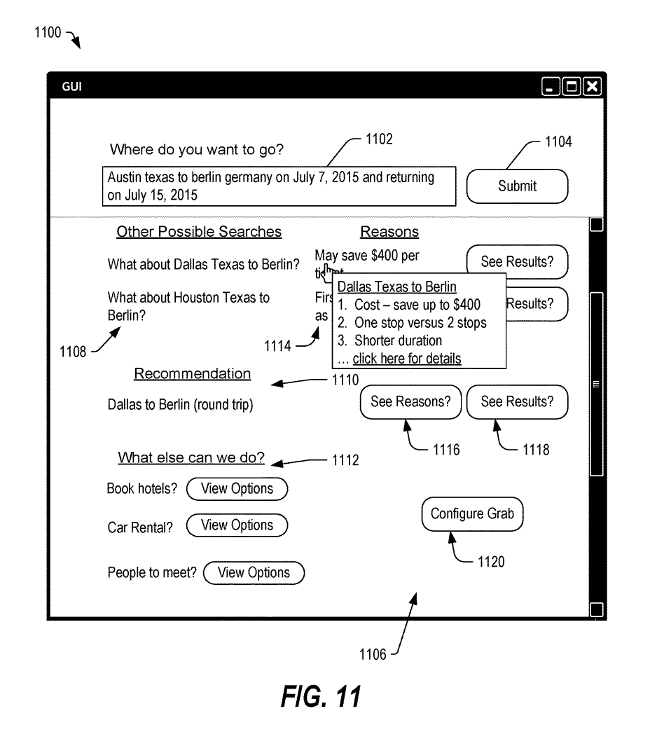

FIG. 11 is a diagram of a GUI 1100 configured to provide outcomes, in accordance with certain embodiments of the present disclosure. The GUI 1100 may include a text field 1102 to receive a text or voice input, such as a natural language input, as well as a plurality of user-selectable elements, such as buttons, check boxes, radio buttons, clickable links, pull-down menus, tabs, clickable images, other elements, or any combination thereof. The GUI 1100 may include a button 1104 (labeled “Submit”) for sending input from the text field 1102 to the intelligent purchasing system for further processing.

In some embodiments, as the user interacts with the text field 1102, data may be exchanged between the GUI 1100 and the collective intelligence experience system. In response to the data from the GUI, the intelligent purchasing system may identify “better” searches based on collective information and may provide information related to the “better” searches to the GUI 1100 for presentation.

In some embodiments, the GUI 1100 may include further information in a recommendations panel 1106 including a list 1108 of other possible searches, which may be better than that entered by the user. The GUI 1100 may further include reasons 1114 why the other searches in the list 1108 may be better and a selectable element labeled “See Results?”, which may be selected by a user to view the results if the particular search is selected. By moving a pointer over one of the reasons, a pop-up window may be displayed which may list one or more reasons why the search may be better and which may provide a selectable element (such as a link) that can be selected by a user to access a more detailed explanation. Alternatively, the user may interact with the system by voice to provide the parameters and to access the various options.

In some embodiments, the GUI 1100 may include a recommendation 1110 of a particular search option. In some embodiments, the recommendation 1110 may include a set of reasons or a detailed explanation, which may be accessed by selecting a “See Reasons?” button 1116. Further, the recommended search and its results may be accessed by clicking the “See Results?” button 1118. In some embodiments, the reasons may be presented in a separate list or may be presented via a popup window when the user locates the pointer over the recommendation 1110. In other embodiments, the buttons 1116 and 1118 may be omitted.

In some embodiments, the GUI 1100 may include further options 1112. In the illustrated example, the further options 1112 are listed below a heading of “What else can we do?” In the illustrated example, the GUI 1100 presents options for booking a hotel, renting a car, meeting people, etc. With respect to the “People to meet?” option, the user may share his or her social or work contacts, schedule information, and other information with the collective intelligence experience system, which may analyze the shared information to identify potential opportunities to meet or to identify scheduled meetings. Selecting the “View Options” button may cause the GUI to present information related to possible or existing meeting schedules and may provide further options for facilitating such meetings. In a particular example, selecting the “View Options” associated with the “People to meet?” label may cause the GUI 1100 to communicate with the intelligent purchasing system to identify a travel option that includes a layover long enough for the user to meet with one or more of his or her contacts. Other features are also possible.

In some embodiments, the GUI 1100 may present “better” search options 1108, reasons for selecting such options 1114, and recommendations 1110 automatically as the user enters his or her request into the text field, while the intelligent purchasing system is processing the request, after the intelligent purchasing system has provided results from searching based on the request, or any combination thereof. In some embodiments, the text field may be replaced with multiple user-selectable data entry elements, which may be of the same or different types. In some embodiments, the interface may be configured to receive audio files or speech input, such as recorded messages, uploaded audio data, or a spoken request (e.g., voice call).

In some embodiments, the GUI 1100 may include a selectable option 1120, labeled “Configure Grab”, which may be accessed by a user to configure a threshold associated with a continuous search and grab option. For example, upon review of available options, the user may want to purchase an available inventory item if the price falls below a threshold, and the user may access the selectable option 1120 to configure a threshold at which the system may be authorized to automatically purchase an inventory item on behalf of the user. Further, the user may access the selectable option 1120 to define a range of values, to assign weights to particular attributes, and to specify whether the system may automatically purchase the inventory item on behalf of the user or if the system may only place an electronic hold on the item. Other embodiments are also possible.

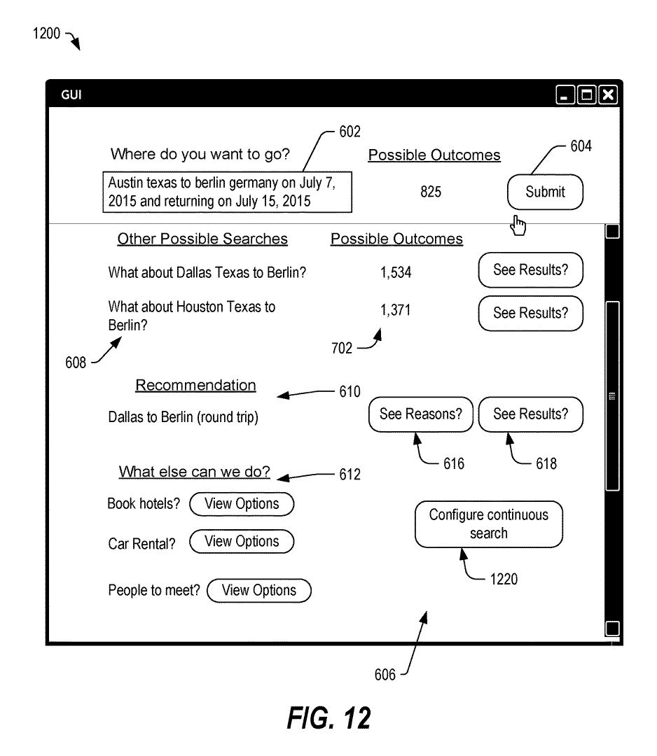

FIG. 12 is a diagram of a second GUI 1200 configured to provide outcomes, in accordance with certain embodiments of the present disclosure. The GUI 1200 may include all of the elements of the GUI 1100 of FIG. 11, except that the reasons 1114 may be replaced with possible outcomes 1202, which possible outcomes may include a number of options found that meet the criteria specified in the text input 1102. In some embodiments, locating the pointer over one of the “possible outcomes” may cause the GUI 1200 to display reasons why that set of outcomes may be “better” for the particular user. Other options are also possible.

The second GUI 1200 may also include a selectable option 720 labeled “Configure continuous search,” which may enable a user to configure the system to continue searching even after the user has purchased an inventory item. Further, the user may configure the system to indicate the conditions under which the system may repurchase, change, or otherwise alter the user's purchase. Other embodiments are also possible.

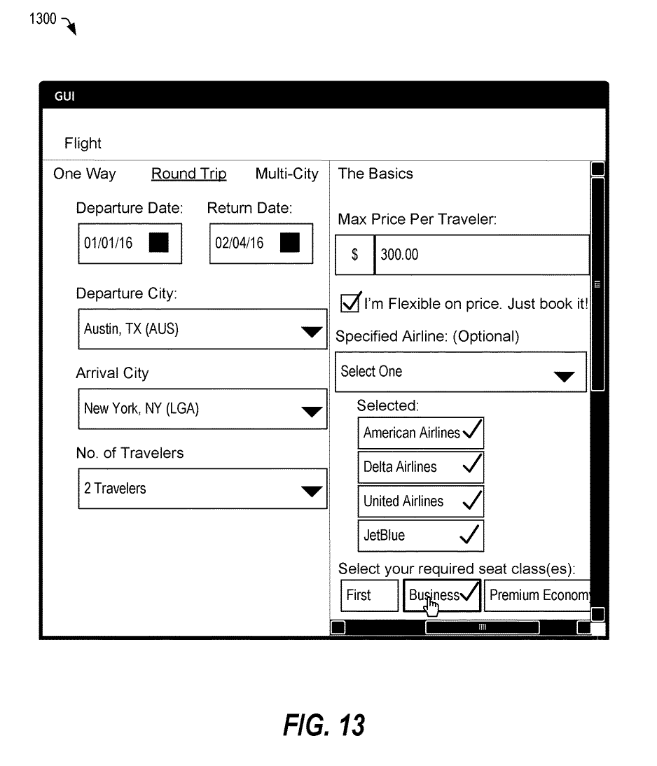

FIG. 13 depicts a diagram of a third GUI 1300 accessible to configure a continuous search and intelligent purchasing, in accordance with certain embodiments of the present disclosure. In the illustrated example, the user may configure various parameters, such as departure date, arrival date, departure and arrival city, number of travelers, and so on. Then, the user may configure a price parameter, date fields, one or more text fields, a check box indicating that the traveler is flexible with respect to timing, other input parameters, or any combination thereof. The interface may provide any number of user-configurable options for defining the parameters.

Further, the traveler can specify his or her preferred airlines and desired class for travel. Other options may also be available. Further, in some examples, the user may scroll down and select one or more options indicating how the artificial intelligence engine may operate on the user's behalf. In one example, by selecting one or more options, the user may authorize the system to purchase a product on his or her behalf or may authorize the system to reserve the product and to notify him or her of the held item so that he or she can review and make a decision. Other embodiments are also possible.

In conjunction with the systems, methods, devices and interfaces described above with respect to FIGS. 1-13, a system may include a processor and a memory accessible to the processor. The memory may be a memory device (volatile or non-volatile) configured to store instructions that, when executed, cause the processor to receive seed data corresponding to an option of interest to a particular user and automatically search for an option that corresponds to the seed data. Further, the system may automatically grab the option on behalf of the user. In a particular example, the system may automatically retrieve search results, rank the results, and grab a result that meets the particular parameters defined by the seed data. In some embodiments, the system may hold the result (such as by adding a particular result to a shopping cart) and may notify the user so that the user can authorize a purchase. In other embodiments, the system may automatically purchase the option on behalf of the user. Other embodiments are also possible.

In certain embodiments, the system may retrieve a plurality of options and may determine a relative value of each of the items to the user based on a comparison between the parameters and the option, based on prior decisions made by the user, based on collective information derived from other users and their decisions, based on other attributes, or any combination thereof. In some embodiments, the collective information may be derived from prior searches, user interactions with search results, and so on. The processor may use the collective information to determine “better” searches, to predict “better” results or outcomes, and so on. In some embodiments, the system may make recommendations and explain why a search is “better” while the user is typing his or her search into a search field of a GUI. In some embodiments, the system may interact with the user via an interactive voice response system, which may be integrated within the system or which may be part of another computing system that communicates with the intelligent purchasing system through a network. In some embodiments, the system may provide an indication of the type, quantity or other factors corresponding to the “better” search to assist the client in making a decision. Moreover, the system may be configured to automatically hold and optionally purchase a “better” option on behalf of the user. Other embodiments are also possible.

Further, the system may be configured to grab products or services on behalf of a user. The grab functionality represents a significant improvement over traditional search engines and conventional purchase transactions, both of which may require the user's direct involvement. In the system described above with respect to FIGS. 1-13, the system may grab a product on behalf of the user without the user having to perform a search. Instead, the system may grab a product on behalf of the user based on one or more parameters defined by the user from which the system may automatically generate searches and may continuously search until an outcome is identified that satisfies the user's parameters. In some embodiments, the system may communicate data related to the parameters to one or more suppliers, one of which may create a product or service that satisfies the parameters, and the system may automatically grab the newly created product or service on behalf of the user. In some embodiments, the system may also continuously search for better options, even after a purchase has been made, and may automatically grab a better option on behalf of the user. Other embodiments are also possible.

The illustrations, examples, and embodiments described herein are intended to provide a general understanding of the structure of various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above examples, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. A system comprising:
a network interface configured to communicate with a network;
a processor coupled to the network interface; and
a memory coupled to the processor and configured to store instructions that, when executed, cause the processor to:
receive seed data corresponding to a product of interest to a user;
search one or more data sources to identify a plurality of products that correspond to the seed data; and
automatically grab a selected product of the plurality of products on behalf of the user.

2. The system of claim 1, wherein the memory further includes instructions that, when executed, cause the processor to:
automatically search one or more sources to identify a second plurality of products for a user after the user has completed a purchase of a selected product;
automatically determine a first product of the second plurality of products that has a better value for the user than the selected product; and
automatically grab the first product on behalf of the user.

3. The system of claim 2, wherein the memory further includes instructions that, when executed, cause the processor to:
automatically hold the first product; and
automatically send an alert to the user to receive authorization to complete a purchase of the first product.

4. The system of claim 3, wherein the memory further includes instructions that, when executed, cause the processor to:
receive an authorization in response to sending the alert; and
complete the purchase of the first product in response to receiving the authorization.

5. The system of claim 2, wherein the instructions to automatically grab the first product cause the processor to:
determine a value of the first product of the plurality of products at least in part based on attributes of the first product relative to preferences of the user; and
automatically grab the first product on behalf of the user when the value exceeds a cost to the user by an amount that is greater than a threshold amount.

6. The system of claim 2, wherein the memory further includes instructions that, when executed, cause the processor to:
determine an initial value of an initial purchase by the user; and
automatically determine a plurality of products having a value that is greater than the initial value of the initial purchase; and
automatically grab a selected product when a difference between the value and the initial value is greater than a threshold amount.

7. The system of claim 1, wherein the plurality of products includes airline tickets.

8. The system of claim 1, wherein the plurality of products include at least one of a vacation rental, a hotel rental, and a campsite rental.

9. A method comprising:
receiving, at a processor of a computing system, seed data including a plurality of parameters corresponding to a product of interest to a user;
automatically determining a plurality of products based on the seed data by searching one or more data sources; and
automatically grabbing a selected one of the plurality of products on behalf of the user based on the plurality of parameters, using the processor of the computing system.

10. The method of claim 9, wherein the seed data comprises a plurality of parameters configured by the user.

11. The method of claim 9, wherein the seed data comprises a plurality of parameters determined from interactions by the user with an interface including data related to a plurality of products.

12. The method of claim 11, wherein receiving the seed data comprises:
receiving data related to a purchased product;
automatically searching one or more data sources to identify the plurality of products based on the purchased product;
automatically processing the plurality of products using an artificial intelligence engine configured according to a persona associated with the user to determine a first product of the plurality of products that has a better value for the user than the purchased product; and
automatically grabbing the first product on behalf of the user using the artificial intelligence engine to communicate with a data source associated with the first product through the network.

13. The method of claim 12, wherein automatically processing the plurality of products comprises:
determining a value of the first product of the plurality of options at least in part based on attributes of the first product relative to preferences of the user, the attributes including at least one of a departure attribute, an arrival attribute, and a duration attribute; and
automatically purchasing the first product on behalf of the user when the value exceeds a cost to the user by an amount that is greater than a threshold amount.

14. The method of claim 13, further comprising:
determining an initial value of an initial purchase by the user; and
determining a cost of an alternative option based on an initial purchase price of the option and an associated change fee.

15. The method of claim 9, wherein automatically grabbing the first product comprises:
automatically placing an electronic hold on the first product by adding the first product to a shopping cart; and
automatically communicating data related to the first product to a computing device associated with the user to seek authorization to complete a purchase transaction.

16. The method of claim 15, wherein automatically communicating the data includes sending to the computing device associated with the user at least one of a text message, a voice message, an email message, and an indicator to an application requesting authorization to complete the purchase transaction.

17. The method of claim 16, further comprising:
receiving an authorization to complete the purchase transaction from the computing device; and
completing a purchase transaction for the first product in response to receiving the authorization.

18. The method of claim 9, wherein the seed data includes parameters corresponding to at least one of an airline ticket, a piece of jewelry, a gift, an activity, a vacation rental, a hotel rental, a car rental, and a campsite rental.

19. A system comprising:
a network interface configured to communicate with a network;
a processor coupled to the network interface; and
a memory coupled to the processor and configured to store instructions that, when executed, may cause the processor to:
receive seed data from a computing device coupled to the network;
determine data corresponding to an available item of value to a user based on the seed data using an artificial intelligence engine; and
automatically grab the available item on behalf of the user.

20. The system of claim 19, wherein the instructions to automatically grab the available item cause the processor to:
automatically place an electronic hold on the available item; and
automatically communicate data related to the available item to the user to seek authorization to complete a purchase transaction.

21. The system of claim 19, wherein the instructions to automatically grab the available item cause the processor to:
select a plurality of products from a supplier based on the seed data; and
automatically complete a purchase transaction for the plurality of products.

22. The system of claim 21, wherein the seed data comprises a grocery list.

23. The system of claim 19, wherein the instructions to automatically grab the available item cause the processor to:
identify multiple items from different suppliers based on the seed data; and
automatically grab at least some of the multiple items on behalf of the user.

24. The system of claim 19, wherein the instructions further include instructions that, when executed, cause the processor to:
provide the seed data to one or more suppliers; and
receive qualified offers from the one or more suppliers in response to the seed data.

25. The system of claim 19, wherein the instructions further include instructions that, when executed, cause the processor to:
automatically suggest changes to the seed data based on yield management rules to improve a likelihood of identifying an item that matches the seed data; and
automatically request authorization to complete the transaction when the item matches the seed data.
